(19) United States
(12) Patent Application Publication
(10) Pub. No.: US 2005/0114105 A1
(43) Pub. Date: May 26, 2005

(54) System for predicting the dynamic behavior of physical systems

(76) Inventor: Andrew J. Barber, Minneapolis, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/996,085

(22) Filed: Nov. 23, 2004

Related U.S. Application Data
(60) Provisional application No. 60/524,297, filed on Nov. 24, 2003.

(51) Int. Cl. G06F 17/10

(52) U.S. Cl. 703/2

(57) ABSTRACT

A system for modeling a physical system comprises an interface configured to receive user inputs defining an adjustment mode and an amplitude for modifying a time history of a physical system, and a calculation engine configured to receive the time history of the physical system, modify the time history based on the defined adjustment and the amplitude, and output the modified time history, which is used to build a modified model of the physical system. The adjustment mode comprises a function template and a basis function.

### CROSS-REFERENCE TO RELATED APPLICATIONS

This application claims the benefit of U.S. Provisional Application Ser. No. 60/524,297, filed Nov. 24, 2003.

### BACKGROUND

Embodiments of the invention apply to the use of computer models of dynamic physical systems, as are becoming increasingly used for scientific and engineering analysis to predict the behavior of the corresponding physical system under various conditions of input. In particular, embodiments of the invention apply to the use of blackbox models for physical systems that represent the system behavior as mathematical functions. The form of the blackbox models are not necessarily derived from actual physics of the system (expressed as physical laws and parameters), but rather as functional fits to some measured time series of input-output data. This input-output data may originate from physical laboratory tests or from simulation with some other computer model.

Mathematical and computer models for analysis of dynamic scientific and engineering systems can be categorized into two distinct families including ‘analytical’ or ‘first principles’ and ‘blackbox’ models. Analytical models are generated by combining information about physical principles, geometry, and physical properties of a system to generate algebraic and differential equations that relate inputs and initial conditions to states and outputs. Analytical models make it possible to predict the behavior of systems that may not physically exist. Furthermore, analytical models allow modification of physical parameters, which may help elucidate the factors responsible for a given dynamic event or behavior, and, for engineering systems, may make it possible to optimize the design in some respects. The term ‘whitebox’ models is gaining acceptance as a synonym for analytical or first principles models, the intent being to contrast with blackbox models.

Blackbox models are generated by fitting mathematical functions to measured input and output data of some system, typically with little or no information about the actual physical makeup of the system. Normally, the measurements are taken from a physical system (e.g., in a laboratory or in a field environment). The inputs for the blackbox model may be controlled or manipulated by the model builder, or they may occur in the normal course of operation of the system. Note that a blackbox model could also be constructed using inputs and outputs from another model. Constructing a blackbox model using inputs and outputs from another model may be useful if the resulting blackbox executes faster.

The main reasons for creating blackbox models include: the physical principles or laws of the system to be modeled may be understood poorly or not at all; a first principles model of the system may be very complex, requiring a large number of variables, which could make it slow or expensive to use for simulation; and/or there may be commercial or similar reasons for sharing a model, while at the same time concealing the physical parameters (i.e., it's okay to share information about the behavior of the specimen, but not its design).

For dynamic systems, the simplest blackbox models usually take the form of a line or curve fitted to a set of data points {(xᵢ, yᵢ)}, where x represents an input, and y an output, and ‘i’ is a an index representing a time variable. More advanced blackbox models arise when there is a hysteresis relationship between input and output. In this case, an accurate model may require ‘higher-dimensional curve fitting’ between a sequence of inputs and the output (i.e., a fit between variables (xᵢ, xᵢ₋₁, . . . xᵢ₋ₘ) and yᵢ). Further possibilities arise when the model uses multiple inputs and outputs, and when the system has substantial energy storage. A very general blackbox characterization may be expressed as follows:
yᵢ=f(xᵢ, . . . xᵢ₋ₘ,yᵢ₋₁, . . . yᵢ₋ₙ) Equation I
Where:
   x, y=vectors (whose elements correspond to multiple input or output channels);
   f=a vector of functions;
   i=an index representing variation with time; and
   m, n=constants representing limits to the amount of past input and output data (respectively) used for the model.

The function f typically consists of a combination of coefficients (or weights) w and one or more basis functions g(x). For example, a polynomial form of the function f may be designated as:
f=Σwᵢgᵢ(x)=w₀+w₁x+w₂x²+w₃x³ Equation II

Two principal tasks associated with blackbox modeling are model generation (i.e., training, fitting) and simulation. A blackbox model is typically generated using the following process:
a) Obtain a set of input and output signal data from the specimen.
b) Choose the form of the basis functions (x^{k}, for the polynomial of Equation II) and the model order, equal to the number of basis functions (three, for the polynomial of Equation II).
c) Calculate weights (or coefficients) wᵢ that optimize the fit of the function f to the measured data points. Typically, the optimal fit is determined by minimizing a least squares error measure.
d) Evaluate the model function f by testing it on an independent set of input-output measurements.

Simulation with a blackbox model is generally straightforward and fast, as the model consists only of algebraic equations. By comparison, simulation using whitebox models may be complex and slow, as the whitebox model is often represented using differential equations, which may require iterative techniques for solution.

There are multiple ways to construct models that combine the whitebox and blackbox approaches. For example, a mechanical device that contains rubber parts may use whitebox equations to represent metal linkages and joints, but a blackbox curve fit may be needed to accurately characterize the rubber. Such models are sometimes called graybox models.

Likewise, there need not be a clear distinction between model generation and simulation. Adaptive filters are blackbox models that generate and continually update the model dynamically (i.e., in a real-time application, they use each new instance of input and output data to improve the model as time progresses).

Blackbox models can be classified using several criteria:
a) Linear vs. nonlinear: Linear systems and models obey the principle of superposition; nonlinear and systems models do not. It is useful to distinguish between systems and their models; for example, a nonlinear system may be modeled using a linear model as a least squares approximation.
b) Instantaneous vs. memory-dependent: If the output of a system/model at any time depends only on the input at that same time, the system/model is instantaneous (or static). Otherwise, it is memory-dependent. Synonyms for memory-dependent include: hysteretic, frequency-dependent, rate-dependent, dynamic. Again, widespread overlap is possible: a system may behave in a static manner at low frequencies, and may exhibit dynamic (memory) effects at high frequencies.
c) Number of inputs and outputs: These refer to independent signals that are used to affect dynamic behavior, or to indicate dynamic behavior, respectively. They do not include isolated constants, physical conditions, initial conditions, or parameters which would affect an entire modification of an output signal. Furthermore, they should not be confused with the number of inputs to a neural network, which may include past values of a given signal as well as the current value (i.e., ‘number of inputs and outputs’ refers to current values only). The acronyms SISO, MISO, MIMO are often used, to represent Single Input, Single Output; Multiple Input, Single Output, etc.
d) Basis function type: may be polynomials, splines, sines (for frequency response function models), and sigmoids (for neural networks).
e) Finite Impulse Response (FIR) or Infinite Impulse Response (IIR): Finite impulse response models depend only on current and past inputs, whereas infinite impulse response models depend as well on past outputs. IIR models generally require fewer coefficients than FIR, for a given accuracy level, but they may become unstable under some conditions, giving completely erroneous responses.

An important consideration when simulating with blackbox models is that blackbox models, by themselves, do not offer any opportunity for adjustment of parameters related to physical variables, which may be useful for studying the effects of various physical variables on model output, or for optimizing the design of the physical system represented by the model. This limitation arises because the blackbox is normally generated using only measured input and output signals, and information about the physical variables is disregarded.

Various methods to circumvent this limitation have been proposed. One method is to form a composite model, consisting of the blackbox plus scale multipliers for the model input and output signals. The intent of these multipliers is to enable simple adjustment of the composite model (i.e., the composite behavior can be made to emulate a component of larger or smaller dimensions (or other physical parameters)). More generally, the scale factors can be supplemented with offsets, applied again to both input and output signals.

Adjusting the ‘size’ and ‘position’ of a model via scaling and offset (a.k.a., stretching and shifting, respectively) adjustments is useful, but blackbox model users desire more powerful capabilities. Ideally, a set of adjustments that mimic the effects of whitebox parameter adjustments would be desirable.

### SUMMARY

One embodiment of the present invention provides a system for modeling a physical system. The system comprises an interface configured to receive user inputs defining an adjustment mode and an amplitude for modifying a time history of a physical system, and a calculation engine configured to receive the time history of the physical system, modify the time history based on the defined adjustment and the amplitude, and output the modified time history, which is used to build a modified model of the physical system. The adjustment mode comprises a function template and a basis function.

### BRIEF DESCRIPTION OF THE DRAWINGS

FIG. 1A is a block diagram illustrating one embodiment of a system for performing CRT adjustments on time histories used for generating models of physical systems.

FIG. 1B is a block diagram illustrating another embodiment of a system for performing CRT adjustments on time histories used for generating models of physical systems.

FIG. 2 is a block diagram illustrating one embodiment of a computer system for implementing the system for performing CRT adjustments on time histories used for generating models of physical systems.

FIG. 3 is a flow diagram illustrating one embodiment of a method for performing CRT adjustments on time histories used for generating models of physical systems.

FIG. 4A is a diagram illustrating one embodiment of a linear basis function.

FIG. 4B is a diagram illustrating one embodiment of applying the linear basis function in an additive template for a parallelogram mode.

FIG. 4C is a diagram illustrating one embodiment of applying the linear basis function in a multiplicative symmetric template for a trapezoid mode.

FIG. 4D is a diagram illustrating one embodiment of applying the linear basis function in a multiplicative antisymmetric template for a twist mode.

FIG. 5A is a diagram illustrating one embodiment of a hinge basis function.

FIG. 5B is a diagram illustrating one embodiment of applying the hinge basis function in an additive template for a hinge mode.

FIG. 5C is a diagram illustrating one embodiment of applying the hinge basis function in a multiplicative symmetric template for a funnel mode.

FIG. 6A is a diagram illustrating one embodiment of a multiple-hinge basis function.

FIG. 6B is a diagram illustrating one embodiment of applying the multiple-hinge basis function in an additive template for a multi-hinge mode.

FIG. 6C is a diagram illustrating one embodiment of applying the multiple-hinge basis function in a multiplicative symmetric template for a multi-funnel mode.

FIG. 7A is a diagram illustrating one embodiment of a bow basis function.

FIG. 7B is a diagram illustrating one embodiment of applying the bow basis function in an additive template for a bow mode.

FIG. 7C is a diagram illustrating one embodiment of applying the bow basis function in a multiplicative symmetric template for a pincushion mode.

FIG. 8A is a diagram illustrating one embodiment of a bow2 basis function.

FIG. 8B is a diagram illustrating one embodiment of applying the bow2 basis function in an additive template for a bow2 mode.

FIG. 8C is a diagram illustrating one embodiment of applying the bow2 basis function in a multiplicative symmetric template for a pincushion2 mode.

FIG. 9A is a diagram illustrating one embodiment of a mound basis function.

FIG. 9B is a diagram illustrating one embodiment of applying the mound basis function in an additive template for a bump mode.

FIG. 9C is a diagram illustrating one embodiment of applying the mound basis function in a multiplicative symmetric template for a bulge mode.

FIG. 10A is a diagram illustrating one embodiment of a sigmoid basis function.

FIG. 10B is a diagram illustrating one embodiment of applying the sigmoid basis function in an additive template for a sigmoid mode.

FIG. 10C is a diagram illustrating one embodiment of applying the sigmoid basis function in a multiplicative symmetric template for a bell mode.

FIG. 10D is a diagram illustrating one embodiment of applying the sigmoid basis function in a multiplicative antisymmetric template for a sigmoid2 mode.

FIG. 11A is a diagram illustrating one embodiment of an inverse sigmoid basis function.

FIG. 11B is a diagram illustrating one embodiment of applying the inverse sigmoid basis function in an additive template for an inverse sigmoid mode.

FIG. 11C is a diagram illustrating one embodiment of applying the inverse sigmoid basis function in a multiplicative symmetric template for a bowl mode.

FIG. 11D is a diagram illustrating one embodiment of applying the inverse sigmoid basis function in a multiplicative antisymmetric template for an inverse sigmoid2 mode.

FIG. 12A is a diagram illustrating one embodiment of an edge sigmoid basis function.

FIG. 12B is a diagram illustrating one embodiment of applying the edge sigmoid basis function in an additive template for an edge sigmoid mode.

FIG. 12C is a diagram illustrating one embodiment of applying the edge sigmoid basis function in a multiplicative symmetric template for a beaker mode.

FIG. 12D is a diagram illustrating one embodiment of applying the edge sigmoid basis function in a multiplicative antisymmetric template for a edge sigmoid2 mode.

FIG. 13A is a diagram illustrating one embodiment of a lanechange basis function.

FIG. 13B is a diagram illustrating one embodiment of applying the lanechange basis function in an additive template for a lanechange mode.

FIG. 13C is a diagram illustrating one embodiment of applying the lanechange basis function in a multiplicative symmetric template for a nozzle mode.

FIG. 13D is a diagram illustrating one embodiment of applying the lanechange basis function in a multiplicative antisymmetric template for a lanechange2 mode.

FIG. 14A is a diagram illustrating one embodiment of a double bow basis function.

FIG. 14B is a diagram illustrating one embodiment of applying the double bow basis function in an additive template for a wave mode.

FIG. 14C is a diagram illustrating one embodiment of applying the double bow basis function in a multiplicative symmetric template for an urn mode.

FIG. 14D is a diagram illustrating one embodiment of applying the double bow basis function in a multiplicative antisymmetric template for a wave2 mode.

FIG. 15A is a diagram illustrating one embodiment of a double swerve basis function.

FIG. 15B is a diagram illustrating one embodiment of applying the double swerve basis function in an additive template for a double swerve mode.

FIG. 15C is a diagram illustrating one embodiment of applying the double swerve basis function in a multiplicative symmetric template for a torso mode.

FIG. 15D is a diagram illustrating one embodiment of applying the double swerve basis function in a multiplicative antisymmetric template for a double swerve2 mode.

FIG. 16 is a diagram illustrating one embodiment of a rotation adjustment.

FIG. 17 is a diagram illustrating one embodiment of a Radial Basis Function (RBF) shift adjustment.

FIG. 18 is a diagram illustrating one embodiment of a nonlinear stretch adjustment.

FIG. 19 is a diagram illustrating one embodiment of a multibend shift (vertical) adjustment.

FIG. 20A is a diagram illustrating one embodiment of a bump adjustment having a bump span.

FIG. 20B is a diagram illustrating another embodiment of a bump adjustment having a different bump span.

FIG. 21A is a diagram illustrating one embodiment of a bump adjustment having a bump centerline.

FIG. 21B is a diagram illustrating another embodiment of a bump adjustment having a different bump centerline.

FIG. 22A is a diagram illustrating one embodiment of a half-plane partial adjustment.

FIG. 22B is a diagram illustrating one embodiment of a quarter-plane partial adjustment.

FIG. 23 is a diagram illustrating one embodiment of a backbone-centered adjustment.

FIG. 24 is a diagram illustrating one embodiment of the use of a multiple-hinge curve that may be used as the backbone in a backbone-centered adjustment.

FIG. 25 is a diagram illustrating one embodiment of singular behavior for a high amplitude adjustment.

FIG. 26 is a diagram illustrating another embodiment of singular behavior for a high amplitude adjustment.

FIG. 27A is a diagram illustrating one embodiment of adjustment limits.

FIG. 27B is a diagram illustrating one embodiment of modifying adjustment limits.

FIG. 27C is a diagram illustrating another embodiment of modifying adjustment limits.

FIG. 28 is a diagram illustrating one embodiment of a plot for a shock absorber load versus velocity.

FIG. 29 is a chart illustrating one embodiment of spinal disc lateral shear force-deformation behavior for applying the CRT adjustments to perform an empirical interpolation.

FIG. 30A is a chart illustrating one embodiment of jounce bumper force-displacement.

FIG. 30B is a chart illustrating one embodiment of applying the CRT adjustments to perform an exploration on the jounce bumper force-displacement.

FIG. 31 is a diagram illustrating one embodiment of a time delay neural network.

FIG. 32 is a diagram illustrating one embodiment of a time delay neural network with constant coefficients illustrated explicitly.

FIG. 33 is a diagram illustrating another embodiment of a time delay neural network with adjustable coefficients.

FIG. 34 is a diagram illustrating one embodiment of interpolation between coefficients for a series of blackbox models.

FIG. 35 is a diagram illustrating one embodiment of interpolation between coefficients for a series of blackbox models derived from whitebox models.

FIG. 36 is a diagram illustrating one embodiment of shifting and stretching a coefficient function.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

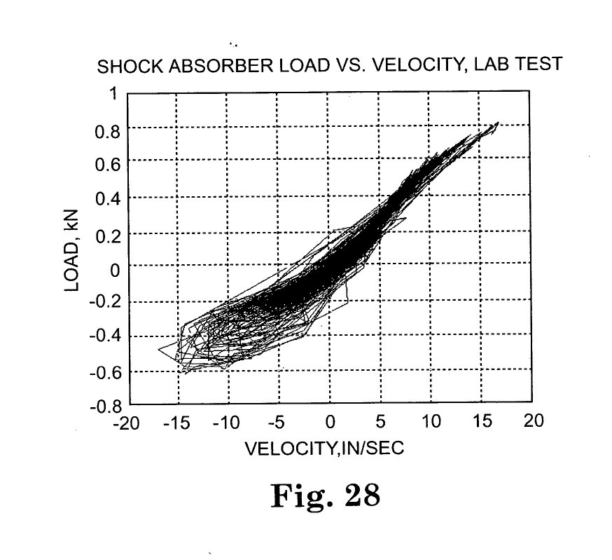

One approach to adjusting blackbox models is to modify the relationship between concurrent input and output values graphically, in a manner analogous to the image corrections typically provided with Cathode Ray Tubes (CRTs). To perform this technique, it is helpful to depict the input-output behavior of a physical system or model using a two-dimensional plot of simultaneous input and output values, where typically, inputs and outputs are plotted along the horizontal and vertical axes, respectively. An example of such a plot, for the force(output)-velocity(input) behavior of an automotive shock absorber subjected to random input, is illustrated in FIG. 28. This plot illustrates that the input-output behavior is very complex, but at the same time there is a definite pattern, with all input-output points clustered around a curve. If either the input or output time history is modified by an adjustment, the new graphical input-output pattern will appear to be a distortion of the original pattern. Conversely, a graphical distortion may be used to define adjustments to the time histories.

Several of the model adjustment methods mimic the corrections provided with many standard Cathode Ray Tubes (CRTs). CRT corrections are used to center, align, and straighten out the CRT image. The corrections are defined in terms of different shapes or ‘modes’ (trapezoid, parallelogram, pincushion), according to the distortion they impart to a rectangular image, and also in terms of an ‘amplitude,’ which is adjusted by a user to minimize image distortions. The model adjustments use these same distortion modes and user-selected amplitudes, but they are applied instead to the input-output signals of a model. This approach makes it easy to understand the global effect of any given model adjustment tool.

The graphical adjustments can be applied in a couple of ways. The most direct way is to apply the 2D graphical transformation equations to the input and output histories to be used for model generation. Using this method, the blackbox model is rebuilt after any new adjustment. An alternative method is to define one or more components that function ‘outside’ of the blackbox, and to modify these in a way that mimics the desired 2D effect.

It is important to understand that the model adjustments described here differ from conventional CRT corrections in several important respects:
a) The goal of model adjustments is to allow users to investigate the behavior of an altered physical system, when that system is modeled using a blackbox method. The goal is not to produce 2D images. Saying this another way: 2D distortions provide a convenient way to interpret and describe the model adjustments, but they are not necessary. The adjustments can be applied algorithmically, with no reference to 2D graphics.
b) Conventional CRT adjustments are generally limited to ‘horizontal’ distortions (i.e., they change the endpoints of any given horizontal raster line, but not the vertical spacing or straightness of the lines). One exception is the ‘tilt’ correction, available on some CRTs. In contrast, most of the model adjustments described herein are applicable to both the horizontal and vertical directions.
c) Embodiments of the invention include a variety of modes not normally available on physical CRTs.
d) Many of the model adjustments described herein have options not available for CRTs. For example, some of the adjustments can be restricted to part of input-output plane (e.g., half plane or quarter plane adjustments). For some adjustments, the user can select a locus of points that remain fixed.

As used herein, the term ‘CRT’ will be used with a relaxed interpretation, to describe model adjustments that have analogs in 2D graphical distortions, regardless of whether those distortions are available or beneficial for cathode ray tube hardware. In one embodiment, standard CRT adjustments include trapezoid, parallelogram, pincushion, bow, and rotate. In one form of the invention, extended CRT adjustments include urn, bell, sigmoid, inverse sigmoid, edge sigmoid, lanechange, double swerve, hinge, funnel, bump, bulge, bowl, beaker, nozzle, wave, torso, and nonlinear stretch. In one embodiment, localized adjustments include radial basis function shift. The individual adjustment methods listed can also be used to perform multiple adjustments in sequence.

A useful option for several of the CRT adjustments is the designation of a locus of fixed points. In one embodiment, the locus of fixed points is the line or curve representing the ‘backbone’ of a set of input-output points. This curve can be defined many ways, for example, as a least-squares polynomial curve fit to the input-output points. By fixing this curve, model users can limit the action of the adjustment to the width or spread of input-output points (or ‘hysteresis’).

One variant of the CRT adjustments applies for cases where the model user wishes to apply a CRT adjustment to the derivative of model input, rather than to the model input itself. This can be useful for models of nonlinear dampers (e.g., shock absorbers), which are sometimes characterized using displacement as the model input, instead of velocity, even though the force (output) is often more directly correlated to velocity. For such a model, the CRT adjustments listed above can only be used to adjust a plot of force versus displacement. To adjust the force versus velocity behavior, special processing is used, whereby displacements are converted to velocities before applying the adjustments.

For many of the 2D adjustments, it is possible to define amplitudes in such a manner as to give a singular (non-invertible) transformation. This can cause the adjusted model to behave very unrealistically. To help guard against these possibilities, the current invention includes a provision to check for singularities and report them to the user.

Another aspect of the invention is a connection between model adjustments and the values of model input and output ‘limits’ or boundaries. An important consideration when simulating with blackbox models is whether the model predictions are valid, in the sense that they are based on inputs and outputs of magnitude similar to those used for generating the model. That is, when a set of input-output data representing measured physical system behavior is used to construct a blackbox model, the minimum and maximum values of those data define the range over which fitted equations may be considered to apply with reasonable accuracy, and beyond which the fitted equations may have an indeterminate accuracy.

These maximum and minimum values effectively serve as ‘validity’ limits, against which actual input and output values may be compared, during simulation with the blackbox model, to indicate that the model is producing accurate or inaccurate results. Model validity limits can be modified whenever adjustments are applied to a model to maintain the perspective that the adjusted model represents an altered physical system. Therefore, the current invention also includes methods to modify the validity limits for each of the new adjustments to maintain this consistency.

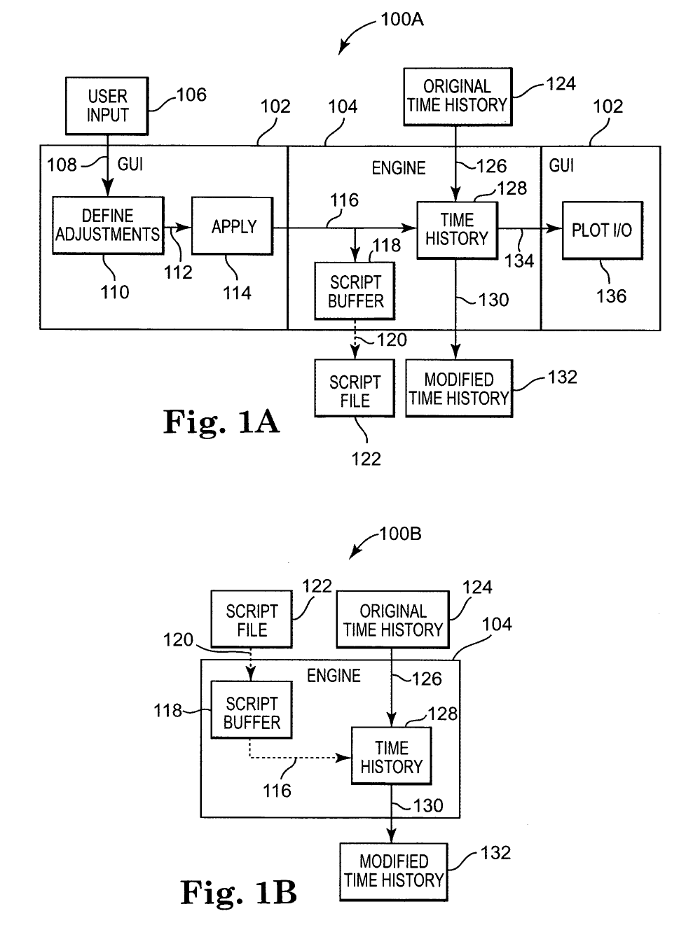

FIGS. 1-3 illustrate a system and method for performing CRT adjustments. FIG. 1 is a block diagram illustrating one embodiment of a system 100A for performing CRT adjustments on time histories used to generate models of physical systems. System 100A is an interactive system used to apply adjustment modes to time histories of models of physical systems to obtain modified time histories, as described in further detail below. System 100A includes a graphical user interface (GUI) 102 and a calculation engine 104. GUI 102 includes the define adjustments block 110, apply block 114, and plot I/O block 136. Calculation engine 104 includes script buffer 118 and time history 128. In one embodiment, script buffer 118 is part of GUI 102. GUI 102 receives user input 106 through communication link 108 as input to define adjustments block 110. Define adjustments block 110 is communicatively coupled to apply block 114 through communication link 112. Apply block 114 is communicatively coupled to script buffer 118 and time history 128 through communication link 116. Script buffer 118 provides script file 122 through communication link 120. Original time history 124 is provided to time history 128 through communication link 126. Time history 128 provides plot I/O 136 through communication link 134. Time history 128 provides modified time history 132 through communication link 130.

FIG. 1B is a block diagram illustrating another embodiment of a system 100B for performing CRT adjustments on time histories used to generate models of physical systems. System 100B is an automatic system used to apply adjustment modes to time histories of models of physical systems to obtain modified time histories, as described in further detail below. System 100B is similar to system 10A, except that GUI 102 is not used.

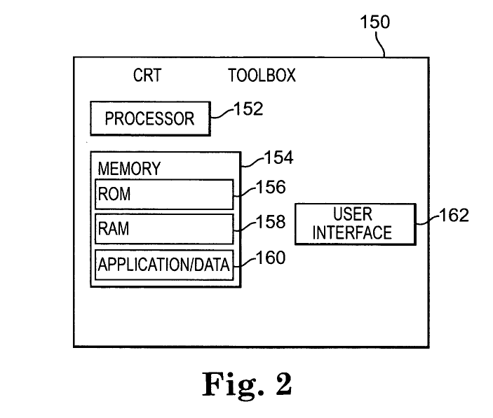

FIG. 2 is a block diagram illustrating one embodiment of a computer system 150 for implementing system 100A and system 100B (FIGS. 1A and 1B). Computer system 150 includes a processor 152, a memory 154, and a user interface 162. Memory 154 includes a read only memory (ROM) 156, a random access memory (RAM) 158, and an application/data memory 160.

Computer system 150 executes an application program for implementing system 100A and system 100B. The application program is loaded from application/data memory 160 or any other computer readable medium. Processor 152 executes commands and instructions for implementing system 100A and system 100B. In one embodiment, ROM 156 stores the operating system for computer system 150, and RAM 159 temporarily stores application data and instructions for implementing system 100A and system 100B. User interface 162 provides an interface to computer system 150 for users to operate system 100A and system 100B. In one embodiment, user interface 162 includes a keyboard, a monitor, a mouse, and/or any other suitable input or output device.

Memory 154 can include main memory, such as a random access memory (RAM) 158, or other dynamic storage device. Memory 154 can also include a static storage device for application/data memory 160, such as a magnetic disk or optical disk. Memory 154 stores information and instructions to be executed by processor 152. In addition, memory 154 stores data for system 100A and system 100B. One or more processors in a multi-processor arrangement can also be employed to execute a sequence of instructions contained in memory 154. In other embodiments, hardwired circuitry can be used in place of or in combination with software instructions to implement system 100A and system 100B. Thus, embodiments of system 100A and system 100B are not limited to any specific combination of hardware circuitry and software.

The term “computer readable medium,” as used herein, refers to any medium that participates in providing instructions to processor 152 for execution. Such a medium can take many forms, including but not limited to, non-volatile media, volatile media, and transmission media. Non-volatile media include, for example, optical or magnetic disks. Volatile media includes dynamic memory. Transition media include coaxial cables, copper wire, and fiber optics. Transmission media can also take the form of acoustic or light waves, such as those generated during radio frequency (RF) and infrared (IR) data communications. Common forms of computer readable media include, for example, a floppy disk, a flexible disk, a hard disk, magnetic tape, any other magnetic mediums, a CD-ROM, DVD, any other optical medium, punch cards, paper tape, any other physical medium with patterns of holes, a RAM, a programmable read-only memory (PROM), an electrical programmable read-only memory (EPROM), an electrically erasable programmable read-only memory (EEPROM), any other memory chip or cartridge, or any other medium from which a computer can read.

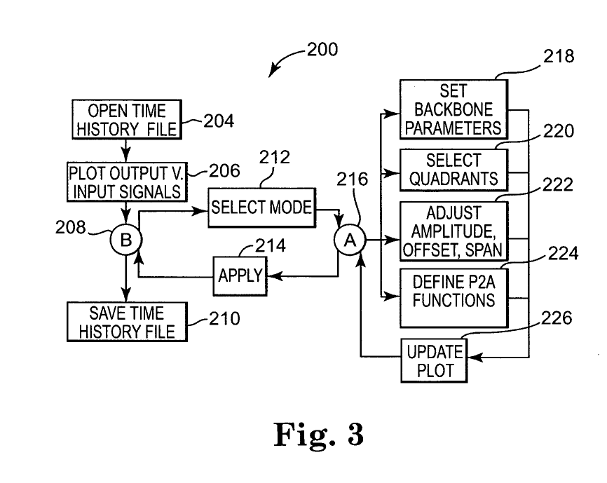

FIG. 3 is a flow diagram illustrating one embodiment of a method 200 for performing CRT adjustments on time histories used to generate models of physical systems. At 204, a user selects a file containing time history data representing simultaneous input and output signals. After passing the time histories through some preliminary checks, at 206, a plot of input versus output signals is displayed graphically. In one embodiment, to improve plotting speed, only a small subset of input-output points is plotted (e.g., a silhouette). At 212, the user is then allowed to select an adjustment mode, which encompasses an adjustment direction (horizontal, vertical, composite) along with function templates and basis functions. Adjustment modes, function templates, and basis functions are discussed in detail later in this detailed description.

The function templates and basis functions may be defined as a combination (e.g., pincushion), or as separate functions (e.g., multiplicative template and ‘bow’ basis function). Once the adjustment mode is selected, the user can adjust various mode-specific parameters (such as amplitude, offset, and span at 222), as well as to define at 220 which ‘quadrants’ of the adjustments are active for partial adjustments, and how the nonlinear backbone is defined and used at 218. During or after each adjustment, at 226 a graphical plot of the output versus input time histories is displayed to provide feedback to the user about the effect of the adjustment. When the user is satisfied with the effect of the various adjustment parameters, the user can invoke an ‘apply’ operation at 214, which applies the new adjustments to the full time history.

Next, the user can save the modified time history at 210, and/or choose to define a new adjustment mode and additional adjustments, which are then applied to the newly modified time history. By applying a series of adjustments to the same time history in succession, elaborate re-shaping of the nonlinear and hysteresis characteristics can be affected. In one embodiment, additional paths through this system, to cancel, undo, or redo any operations, may be implemented as well.

When the user invokes the apply operation at 214, an additional action is performed, to write the adjustment parameters as an ‘editing instruction’ or command to the list called script buffer 118. Script buffer 118 can optionally be saved to an external file 122, for later reuse, as described in the next section.

The diagram depicts two primary internal states ‘A’ 216 and ‘B’ 208, denoting ‘adjustment’ and ‘base’ respectively. The paths to these states help ensure that adjustments can be made (from A) only after a mode is selected, and that outstanding adjustments are confirmed (via the apply function 214) before a new adjustment mode can be selected at 212. (Alternatively, a cancel function may be used to go from A 216 to B 208, in which case the latest adjustments are discarded before a new adjustment mode is selected.

FIGS. 1A and 1B illustrate an architecture for the system 100A and system 100B, which enables an interactive operation mode (as described above), as well as an automatic mode. In the automatic mode, a script of adjustment commands 122 saved from an earlier interactive session is subsequently applied to a different time history, so the user does not have to repeat all the adjustment selections.

FIG. 1A illustrates that the interactive mode requires two principal software components: a graphical user interface (GUI) 102 component and a calculation engine 104. In one embodiment, GUI 102 is a single software component; it is shown split into two parts on either side of calculation engine 104 for clarity. GUI 102 is used to facilitate user input, and engine 104 performs the mathematical transformations and file I/O operations. In this case, calculation engine 104 operations are controlled from GUI 102 as well.

FIG. 1B illustrates that for the automatic mode, only calculation engine 104 is used. In one embodiment, the operation of calculation engine 104 is controlled by a self-contained automation subroutine, so GUI 102 commands are not used. In this embodiment, the user provides the filenames of the time history 124 and the script file 122. In one embodiment, this information may be provided via a command line form, such as: CRTEngine <inputtimehistoryname><scriptname><outputtimehistoryname>. Additional command line switches may be implemented to define special operation modes.

CRT adjustments use adjustments, modes, templates, and basis functions. An adjustment in the form x′ or y′=g(x,y), where x represents a blackbox model input, y represents a model output, g is a continuous, non-singular bivariate function, x′ represents an adjusted input, and y′ represents an adjusted model output, will be considered to consist of a ‘direction,’ a ‘mode,’ and an ‘amplitude.’ The direction is either vertical (output based) or horizontal (input based). Mode defines the shape of function g, and amplitude serves to determine a magnitude or extent of the adjustment. In practice, a user of the model adjustments will normally select one or more modes from a list of available modes, and will then define the amplitude as desired.

A mode will be considered to consist of a function template and a basis function. The function template consists of a functional form involving a basis function, along with constants that represent parameters like amplitude, position, and others. For example, an input (horizontal) adjustment may take the form:
x′=g(x,y)=x+a1*h(a₂y−a₃)=x+a₁*4*(a₂y−a₃)\hat{ }2 Equation III
y′=y Equation IV

In Equation III, the actual adjustment is =x+a₁*4*(a₂y−a₃)\hat{ }2, where a₁ is the amplitude (a₂, a₃ are other user defined scale and position parameters), the function template is x+a₁*h(a₂y−a₃), and h(z)=4z\hat{ }2 is the basis function.

This invention does not specify the functions h as particular mathematical equations, but rather in terms of their properties, which is sufficient to provide the desired effect. For example, the above equation uses a quadratic basis function h(z)=4z\hat{ }2 to implement a ‘bow’ distortion of the input-output plane. That is, it implements a distortion in a manner similar to the ‘bow’ adjustment of a conventional CRT: originally vertical lines are distorted into smooth curves shaped like an archer's bow (and horizontal lines remain horizontal). Such a shape could be implemented using other mathematical equations (e.g., x′=x+a cos b*y). The actual choice of the function is not critical, as long as it yields a bow-like shape. Thus, this specification only defines the crucial properties of a bow shape basis function: smooth, symmetric, ‘bi-monotone’ (i.e., it is monotone on each side of its symmetry axis at y=b), and having a curvature (2^{nd} derivative) with uniform sign (always >0 or always <0).

In one embodiment, there are seven basic types of function templates, plus some minor variations including additive, multiplicative (symmetric and antisymmetric), inverse multiplicative (symmetric and antisymmetric), nonlinear stretch, and Radial Basis Function (RBF) shift. The seven basic types of function templates provide the function templates defined in Equations V-XLV below. Variations of the seven basic types of function templates include application of the function over only part of the plane and the choice of y_{c} and x_{c} as constants or functions (lines or a curves) of x or y, respectively.

Multiplicative inverse modes are similar to the multiplicative modes when the amplitude sign is changed. That is, y/(1+a h( )) is similar to y*(1−a h( )) when the amplitudes are small. The multiplicative inverses offer the possibility of completely canceling the effect of a multiplicative mode. Completely canceling the effect of a multiplicative mode is not possible using multiplicative modes alone.

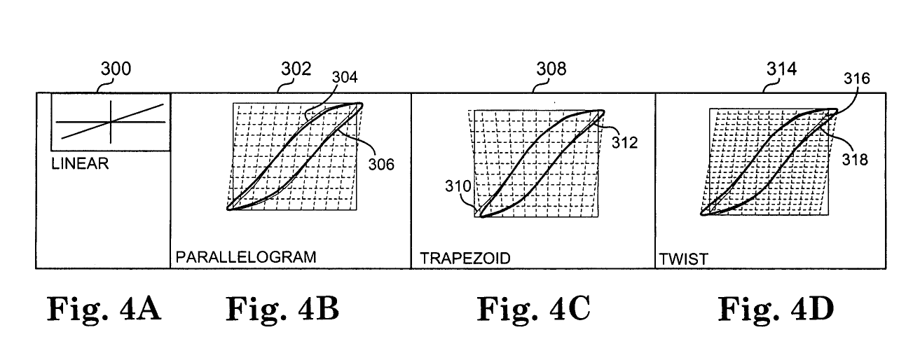

The basis functions are described with reference to FIGS. 4-14 below. Again, these functions are defined in terms of properties, not particular mathematical equations. Function properties cover such aspects as:
a) continuous and smooth (standard mathematical definitions);
b) symmetric or antisymmetric;
c) presence of constant values or asymptotes in various locations; and
d) relations between the signs of the function and its derivatives.

These properties have been selected to achieve several goals, including:
a) mimic the standard CRT controls;
b) provide a wide variety of possible planar distortions, especially when used in combination; and
c) inflict minimal ‘counter-reality’ on the model dynamics, for instance, smooth functions are used so as to prevent abrupt, unrealistic changes in the behavior of the adjusted model.

In specifying the basis functions, the function shapes are the key attributes. Function properties are used to define the shapes unambiguously. Thus, any operations that enlarge these shapes, or invert them, or change direction, are considered to be equivalent.

For many adjustment modes, a range of application is designated. As the adjustments are defined in terms of their effect on a rectangular region of input-output space, the rectangular region needs to be defined. Further, the amplitude of many adjustments is most suitably defined as a fraction of the range. A key issue for defining the range is how the application range relates to the model validity range. It will often prove useful to define the range of application to be the same as the validity range, as specified by minimum and maximum input and output values used for building the model. It may sometimes be more useful, however, to define the range to be larger or smaller than the validity range (e.g., when applying an identical adjustment to two different models, which have different validity ranges). A good choice of application range in many cases is the model validity range.

Adjustments are implemented in a straightforward manner, by applying the adjustment function g(x,y) to the input or output time history to generate new time histories, followed by generation of a new blackbox model with the new time histories. For vertical adjustments, the horizontal coordinates are not changed, and for horizontal adjustments, the vertical coordinates are not changed.

A vertical adjustment to the input-output relation of a model of a physical system is defined by the following:
y′=g(x,y) Equation V
Where:
   x=an input signal value;
   y=an output signal value;
   y′=a modified output signal value; and
   g( )=a function applied to an input time history and output time history used for model generation, or directly to the model output y.

An additive vertical adjustment to the input-output relation of a model of physical system is defined by the following:
y′=x+a₁*h(a₂x−a₃) Equation VI
Where:
   x=an input signal value;
   y′=a modified output signal value;
   a₁, a₂, a₃=constants; and
   h( )=a smooth, univariate function.

In one embodiment, a multiplicative vertical symmetric adjustment to the input-output relation of a model of physical system is defined by the following:
y′=y_{c}+(y−y_{c})[1+a₁*h(a₂x−a₃)], for all y Equation VII
Where:
   x=an input signal value;
   y=an output signal value;
   y′=a modified output signal value;
   y_{c}=a constant or function of x;
   a₁, a₂, a₃=constants; and
   h( )=a smooth, univariate function.

In another embodiment, a multiplicative vertical symmetric adjustment to the input-output relation of a model of physical system is defined by the following Equations VIII and IX:
y′=y_{c}+(y−y_{c})[1+a₁*h(a₂x−a₃)], for y>y_{c} Equation VIII
Where:
   x=an input signal value;
   y=an output signal value;
   y′=a modified output signal value;
   y_{c}=a constant or function of x;
   a₁, a₂, a₃=constants; and
   h( )=a smooth, univariate function.
      y′=y, for y<y_{c} Equation IX
Where:
   y=an output signal value;
   y′=a modified output signal value; and
   y_{c}=a constant or function of x.

In another embodiment, a multiplicative vertical symmetric adjustment to the input-output relation of a model of physical system is defined by the following Equations X and XI:
y′=y_{c}+(y−y_{c})[1+a₁*h(a₂x−a₃)], for y<y_{c} Equation X
Where:
   x=an input signal value;
   y=an output signal value;
   y′=a modified output signal value;
   y_{c}=a constant or function of x;
   a₁, a₂, a₃=constants; and
   h( )=a smooth, univariate function.
      y′=y, for y>y_{c} Equation XI
Where:
   y=an output signal value;
   y′=a modified output signal value; and
   y_{c}=a constant or function of x.

A multiplicative vertical antisymmetric adjustment to the input-output relation of a model of physical system is defined by the following:
y′=y_{c}+(y−y_{c})[1+sign(y)*a₁*h(a₂x−a₃)] Equation XII
Where:
   x=an input signal value;
   y=an output signal value;
   y′=a modified output signal value;
   y_{c}=a constant or function of x;
   a₁, a₂, a₃=constants;
   sign( )=a signum function; and
   h( )=a smooth, univariate function.

In one embodiment, a nonlinear vertical stretch adjustment to the input-output relation of a model of physical system is defined by the following:
y′=y+a₁*h(a₂y−a₃), for all y Equation XIII
Where:
   y′=a modified output signal value;
   y=an output signal value;
   a₁, a₂, a₃=constants; and
   h( )=a smooth, monotonic, univariate function, with slope >−1.

In another embodiment, the nonlinear stretch adjustment to the input-output relation of a model of physical system is defined by the following Equations XIV and XV:
y′=y+a₁*h(a₂y−a₃), for y>b Equation XIV
Where:
   y′=a modified output signal value;
   y=an output signal value;
   a₁, a₂, a₃, b=constants; and
   h( )=a smooth, monotonic, univariate function, with slope >−1.
      y′=y, for y<b Equation XV
Where:
   y′=a modified output signal value;
   y=an output signal value; and
   b=constant.

In another embodiment, the nonlinear stretch adjustment to the input-output relation of a model of physical system is defined by the following Equations XVI and XVII:
y′=y+a₁*h(a₂y−a₃), for y<b Equation XVI
Where:
   y′=a modified output signal value;
   y=an output signal value;
   a₁, a₂, a₃, b=constants; and
   h( )=a smooth, monotonic, univariate function, with slope >−1.
      y′=y, for y>b Equation XVII
Where:
   y′=a modified output signal value;
   y=an output signal value; and
   b=constant.

A vertical radial basis function (RBF) shift adjustment to the input-output relation of a model of physical system is defined by the following:
y′=y+a₁*h((a₂x−a₃)²+(a₄y−a₅)²) Equation XVIII
Where:
   y′=a modified output signal value;
   y=an output signal value;
   x=an input signal value;
   a₁, a₂, a₃, a₄, a₅=constants; and
   h( )=a mound function (smooth, symmetric, bi-monotonic, univariate, nonzero finite-valued at origin, and asymptotically constant.

In one embodiment, an inverse multiplicative vertical symmetric adjustment to the input-output relation of a model of physical system is defined by the following Equation XIX:
y′=y_{c}+(y−y_{c})/[1+a₁*h(a₂x−a₃)], for all y Equation XIX
Where:
   y′=a modified output signal value;
   y=an output signal value;
   y_{c}=a constant of a function of x;
   x=an input signal value;
   a₁, a₂, a₃=constants; and
   h( )=a smooth, univariate function.

In another embodiment, an inverse multiplicative vertical symmetric adjustment to the input-output relation of a model of physical system is defined by the following Equations XX and XXI:
y′=y_{c}+(y−y_{c})/[1+a₁*h(a₂x−a₃)], for y>y_{c} Equation XX
Where:
   y′=a modified output signal value;
   y=an output signal value;
   y_{c}=a constant of a function of x;
   x=an input signal value;
   a₁, a₂, a₃=constants; and
   h( )=a smooth, univariate function.
      y′=y for y<y_{c} Equation XXI
Where:
   y′=a modified output signal value;
   y=an output signal value; and
   y_{c}=a constant of a function of x.

In one embodiment, an inverse multiplicative vertical symmetric adjustment to the input-output relation of a model of physical system is defined by the following Equation XXII and XXIII:
y′=y_{c}+(y−y_{c})/[1+a₁*h(a₂x−a₃)], for y<y_{c} Equation XXII
Where:
   y′=a modified output signal value;
   y=an output signal value;
   y_{c}=a constant of a function of x;
   x=an input signal value;
   a₁, a₂, a₃=constants; and
   h( )=a smooth, univariate function.
      y′=y for y>y_{c} Equation XXIII
Where:
   y′=a modified output signal value;
   y=an output signal value; and
   y_{c}=a constant of a function of x.

An inverse multiplicative vertical antisymmetric adjustment to the input-output relation of a model of physical system is defined by the following:
y′=y_{c}+(y−y_{c})/[1+sign(y)*a₁*h(a₂x−a₃)], Equation XXIV
Where:
   y′=a modified output signal value;
   y=an output signal value;
   y=a constant of a function of x
   x=an input signal value;
   a₁, a₂, a₃=constants;
   sign( )=a signum function; and
   h( )=a smooth, univariate function.

A horizontal adjustment to the input-output relation of a model of physical system is defined by the following:
x′=g(x,y) Equation XXV
Where:
   x=an input signal value;
   x′=a modified input signal value;
   y=an output signal value; and
   g( )=a function applied to an input time history and an output time history used for model generation.

An additive horizontal adjustment to the input-output relation of a model of physical system is defined by the following:
x′=x+a₁*h(a₂y−a₃) Equation XXVI
Where:
   x=an input signal value;
   x′=a modified input signal value;
   y=an output signal value;
   a₁, a₂, a₃=constants; and
   h( )=is a smooth, univariate function.

In one embodiment, a multiplicative horizontal adjustment to the input-output relation of a model of physical system is defined by the following Equation XXVII:
x′=x_{c}+(x−x_{c})[1+a₁*h(a₂y−a₃)], for all x Equation XXVII
Where:
   x=an input signal value;
   x′=a modified input signal value;
   x_{c}=is a constant or a function of y;
   y=an output signal value;
   a₁, a₂, a₃=constants; and
   h( )=is a smooth, univariate function.

In another embodiment, a multiplicative horizontal adjustment to the input-output relation of a model of physical system is defined by the following Equations XXVIII and XXIX:
x′=x_{c}+(x−x_{c})[1+a₁*h(a₂y−a₃)], for x>x_{c} Equation XXVIII
Where:
   x=an input signal value;
   x′=a modified input signal value;
   x_{c}=is a constant or a function of y;
   y=an output signal value;
   a₁, a₂, a₃=constants; and
   h( )=is a smooth, univariate function.
      x′=x for x<x_{c} Equation XXIX
Where:
   x=an input signal value;
   x′=a modified input signal value; and
   x_{c}=is a constant or a function of y.

In another embodiment, a multiplicative horizontal adjustment to the input-output relation of a model of physical system is defined by the following Equations XXX and XXXI:
x′=x_{c}+(x−x_{c})[1+a₁*h(a₂y−a₃)], for x<x_{c} Equation XXX
Where:
   x=an input signal value;
   x′=a modified input signal value;
   x_{c}=is a constant or a function of y;
   y=an output signal value;
   a₁, a₂, a₃=constants; and
   h( )=is a smooth, univariate function.
      x′=x for x>x_{c} Equation XXXI
Where:
   x=an input signal value;
   x′=a modified input signal value; and
   x_{c}=is a constant or a function of y.

A multiplicative horizontal antisymmetric adjustment to the input-output relation of a model of physical system is defined by the following:
x′=x_{c}+(x−x_{c})[1+sign(x)*a₁*h(a₂y−a₃)], Equation XXXII
Where:
   x=an input signal value;
   x′=a modified input signal value;
   x_{c}=is a constant or a function of y;
   y=an output signal value;
   a₁, a₂, a₃=constants;
   sign( )=a signum function; and
   h( )=is a smooth, univariate function.

In one embodiment, a nonlinear horizontal stretch adjustment to the input-output relation of a model of physical system is defined by the following Equation XXXIII:
x′=x+a₁*h(a₂x−a₃), for all x Equation XXXIII
Where:
   x=an input signal value;
   x′=a modified input signal value;
   a₁, a₂, a₃=constants;
   h( )=is a smooth, monotonic, univariate function, with slope >−1.

In one embodiment, a nonlinear horizontal stretch adjustment to the input-output relation of a model of physical system is defined by the following Equations XXXIV and XXXV:
x′=x+a₁*h(a₂x−a₃), for x>b Equation XXXIV
Where:
   x=an input signal value;
   x′=a modified input signal value;
   a₁, a₂, a₃, b=constants;
   h( )=is a smooth, monotonic, univariate function, with slope >−1.
      x′=x, for x<b Equation XXXV
Where:
   x=an input signal value;
   x′=a modified input signal value; and
   b=constant.

In one embodiment, a nonlinear horizontal stretch adjustment to the input-output relation of a model of physical system is defined by the following Equations XXXVI and XXXVII:
x′=x+a₁*h(a₂x−a₃), for x<b Equation XXXVI
Where:
   x=an input signal value;
   x′=a modified input signal value;
   a₁, a₂, a₃, b=constants;
   h( )=is a smooth, monotonic, univariate function, with slope >−1.
      x′=x, for x>b Equation XXXVII
Where:
   x=an input signal value;
   x′=a modified input signal value; and
   b=constant.

A horizontal RBF shift adjustment to the input-output relation of a model of physical system is defined by the following:
x′=x+a₁*h((a₂y−a₃)²+(a₄x−a₅)²) Equation XXXVIII
Where:
   x=an input signal value;
   x′=a modified input signal value;
   y=an output signal value;
   a₁, a₂, a₃, a₄, a₅=constants;
   h( )=is a mound function (smooth, symmetric, bi-monotonic, univariate, nonzero finite-valued at origin, and asymptotically constant).

In one embodiment, an inverse multiplicative horizontal adjustment to the input-output relation of a model of physical system is defined by the following Equation XXXIX:
x=x_{c}+(x−x_{c})/[1+a₁*h(a₂y−a₃)], for all x Equation XXXIX
Where:
   x=an input signal value;
   x′=a modified input signal value;
   x_{c}=a constant or function of y;
   y=an output signal value;
   a₁, a₂, a₃=constants;
   h( )=is a smooth, univariate function.

In another embodiment, an inverse multiplicative horizontal adjustment to the input-output relation of a model of physical system is defined by the following Equations XL and XLI:
x′=x_{c}+(x−x_{c})/[1+a₁*h(a₂y−a₃)], for x>x_{c} Equation XL
Where:
   x=an input signal value;
   x′=a modified input signal value;
   x_{c}=a constant or function of y;
   y=an output signal value;
   a₁, a₂, a₃=constants;
   h( )=is a smooth, univariate function.
      x′=x for x<x_{c} Equation XLI
Where:
   x=an input signal value;
   x′=a modified input signal value; and
   x_{c}=a constant or function of y.

In another embodiment, an inverse multiplicative horizontal adjustment to the input-output relation of a model of physical system is defined by the following Equations XLII and XLIII:
x=x_{c}+(x−x_{c})/[1+a₁*h(a₂y−a₃)], for x<x_{c} Equation XLII
Where:
   x=an input signal value;
   x′=a modified input signal value;
   x_{c}=a constant or function of y;
   y=an output signal value;
   a₁, a₂, a₃=constants;
   h( )=is a smooth, univariate function.
      x′=x for x>x_{c} Equation XLIII
Where:
   x=an input signal value;
   x′=a modified input signal value; and
   x_{c}=a constant or function of y.

An inverse multiplicative horizontal antisymmetric adjustment to the input-output relation of a model of physical system is defined by the following:
x′=x_{c}+(x−x_{c})/[1+sign(x)*a₁*h(a₂y−a₃)] Equation XLIV
Where:
   x=an input signal value;
   x′=a modified input signal value;
   x_{c}=a constant or function of y;
   y=an output signal value;
   a₁, a₂, a₃=constants;
   sign( )=a signum function; and
   h( )=is a smooth, univariate function.

The y_{c} as a function of x (for vertical adjustments) has one of the following forms:
a) A straight line.
b) A static neural network, of the form:

$${y}_{c} ( x ) = {\sum }_{i = 1}^{H} {v}_{i} tanh ( {W}_{i} x + {b}_{i} ) + c \qquad Equation XLV$$

Where:
   x=an input signal value;
   Wᵢ, vᵢ, bᵢ, c=neural network coefficients (i.e., weights);
   i=an index; and
   H=a constant.
c) A polynomial.
d) A cubic spline model.
e) A ‘smooth piecewise-linear’ function, of the form:

$${y}_{c} ( x ) = x + {\sum }_{i = 1}^{N} {a}_{i} log ( exp ( \frac{x - {c}_{i}}{{b}_{i}} ) + 1 ) - {a}_{i} log ( {b}_{i} ) \qquad Equation XLVI$$

Where:
   x=an input signal value;
   aᵢ; bᵢ; cᵢ=constants;
   i=an index; and
   N=a constant.

The x_{c} as a function of y (for horizontal adjustments) has one of the following forms:
a) A straight line.
b) A static neural network, of the form:

$${x}_{c} ( y ) = {\sum }_{i = 1}^{H} {v}_{i} tanh ( {W}_{i} y + {b}_{i} ) + c \qquad Equation XLVII$$

Where:
   y=an output signal value;
   Wᵢ, vᵢ, bᵢ, c=neural network coefficients (i.e., weights); and
   H=a constant.
c) A polynomial.
d) A cubic spline model
e) A ‘smooth piecewise-linear’ function, of the form:

$${x}_{c} ( y ) = x + {\sum }_{i = 1}^{N} {a}_{i} log ( exp ( \frac{y - {c}_{i}}{{b}_{i}} ) + 1 ) - {a}_{i} log ( {b}_{i} ) \qquad Equation XLVIII$$

Where:
   y=an output signal value;
   aᵢ; bᵢ; cᵢ=constants;
   i=an index; and
   N=a constant.

In one embodiment, the same y_{c} function is used for all the adjustments made in the composite vertical adjustment. In another embodiment, the same y_{c} function is not used for all the adjustments made in the composite vertical adjustment. In one embodiment, the same x_{c} function is used for all the adjustments made in the composite horizontal adjustment. In another embodiment, the same x_{c} function is not used for all the adjustments made in the composite horizontal adjustment.

FIG. 4A is a diagram illustrating one embodiment of a linear basis function 300. Linear basis function 300 has the following function properties: affine. FIG. 4B is a diagram illustrating one embodiment of applying linear basis function 300 in an additive template for a parallelogram mode 302. Linear basis function 300 is applied to hysteresis plot 304 to provide hysteresis plot 306. FIG. 4C is a diagram illustrating one embodiment of applying linear basis function 300 in a multiplicative symmetric template for a trapezoid mode 308. Linear basis function 300 is applied to hysteresis plot 310 to provide hysteresis plot 312. FIG. 4D is a diagram illustrating one embodiment of applying linear basis function 300 in a multiplicative antisymmetric template for a twist mode 314. Linear basis function 300 is applied to hysteresis plot 316 to provide hysteresis plot 318. Linear basis function 300 can also be applied in an inverse multiplicative template for FIGS. 4C and 4D. Linear basis function 300 is illustrated as applied in FIGS. 4B-4D in the horizontal direction, however, linear basis function 300 can also be applied in the vertical direction.

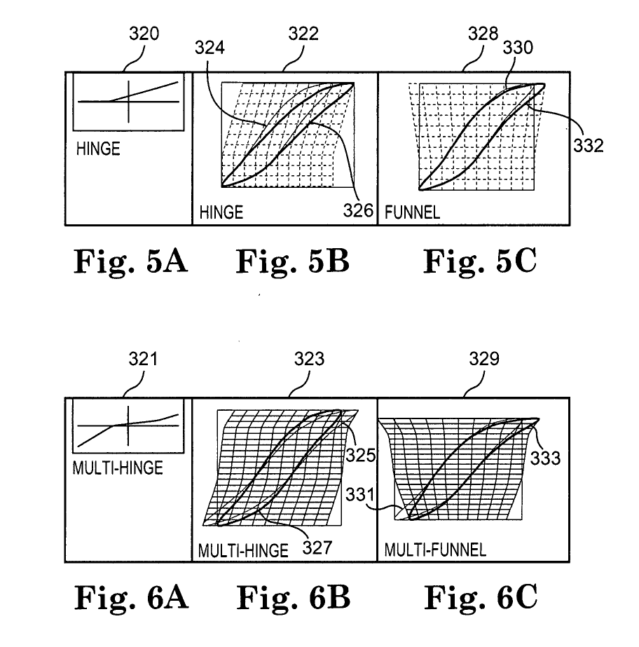

FIG. 5A is a diagram illustrating one embodiment of a hinge basis function 320. Hinge basis function 320 has the following function properties: piecewise linear with smooth transitions. FIG. 5B is a diagram illustrating one embodiment of applying hinge basis function 320 in an additive template for a hinge mode 322. Hinge basis function 320 is applied to hysteresis plot 324 to provide hysteresis plot 326. FIG. 5C is a diagram illustrating one embodiment of applying hinge basis function 320 in a multiplicative symmetric template for a funnel mode 328. Hinge basis function 320 is applied to hysteresis plot 330 to provide hysteresis plot 332. Hinge basis function 320 can also be applied in an inverse multiplicative template for FIG. 5C. Hinge basis function 320 is illustrated as applied in FIGS. 5B and 5C in the horizontal direction, however, hinge basis function 320 can also be applied in the vertical direction.

FIG. 6A is a diagram illustrating one embodiment of a multiple-hinge basis function 321. Multiple-hinge basis function 321 has the following function properties: piecewise linear with smooth transitions. FIG. 6B is a diagram illustrating one embodiment of applying multiple-hinge basis function 321 in an additive template for a multi-hinge mode 323. Multiple-hinge basis function 321 is applied to hysteresis plot 325 to provide hysteresis plot 327. FIG. 6C is a diagram illustrating one embodiment of applying multiple-hinge basis function 321 in a multiplicative symmetric template for a multi-funnel mode 329. Multiple-hinge basis function 321 is applied to hysteresis plot 331 to provide hysteresis plot 333. Multiple-hinge basis function 321 can also be applied in an inverse multiplicative template for FIG. 6C. Multiple-hinge basis function 321 is illustrated as applied in FIGS. 6B and 6C in the horizontal direction, however, multiple-hinge basis function 321 can also be applied in the vertical direction.

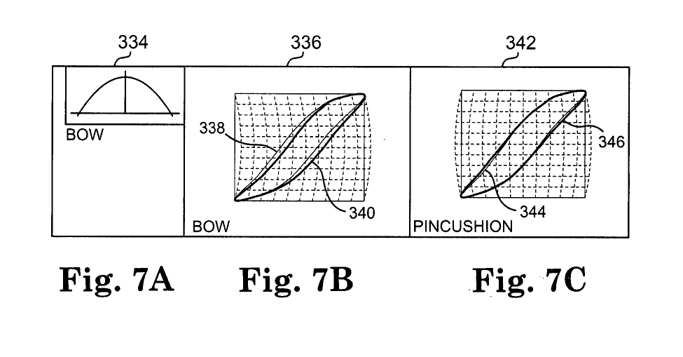

FIG. 7A is a diagram illustrating one embodiment of a bow basis function 334. Bow basis function 334 has the following function properties: symmetric, bi-monotonic, nonzero finite valued at origin, has finite zeros. FIG. 7B is a diagram illustrating one embodiment of applying bow basis function 334 in an additive template for a bow mode 336. Bow basis function 334 is applied to hysteresis plot 338 to provide hysteresis plot 340. FIG. 7C is a diagram illustrating one embodiment of applying bow basis function 334 in a multiplicative symmetric template for a pincushion mode 342. Bow basis function 334 is applied to hysteresis plot 344 to provide hysteresis plot 346. Bow basis function 334 can also be applied in an inverse multiplicative template for FIG. 7C. Bow basis function 334 is illustrated as applied in FIGS. 7B and 7C in the horizontal direction, however, bow basis function 334 can also be applied in the vertical direction.

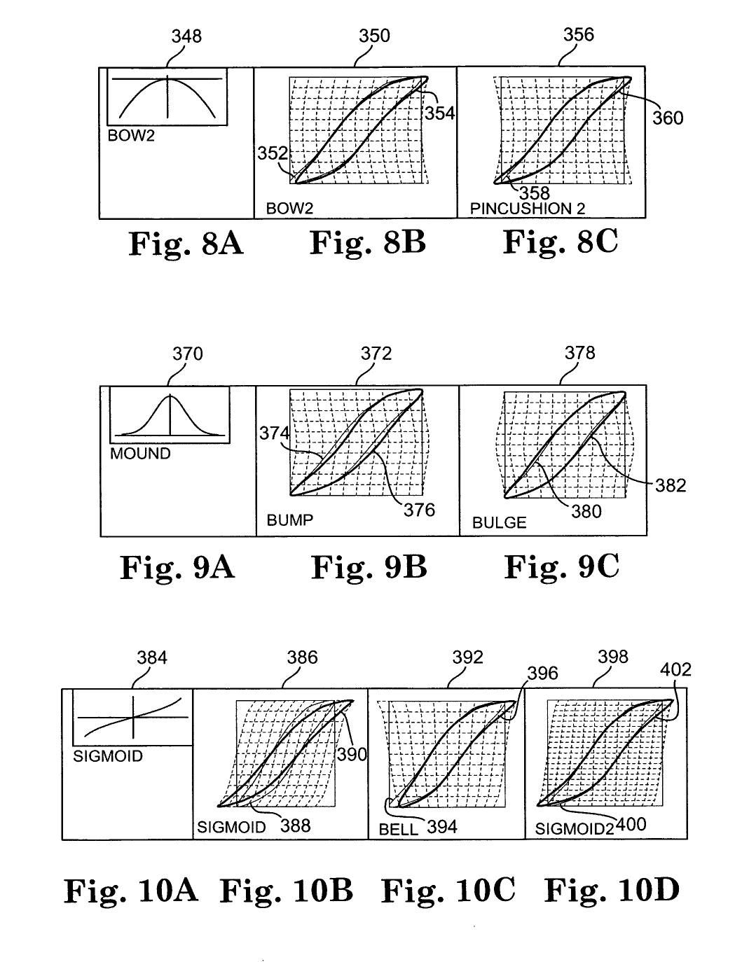

FIG. 8A is a diagram illustrating one embodiment of a bow2 basis function 348. Bow2 basis function 348 has the following function properties: symmetric, bi-monotonic, zero at origin. FIG. 8B is a diagram illustrating one embodiment of applying bow2 basis function 348 in an additive template for a bow2 mode 350. Bow2 basis function 348 is applied to hysteresis plot 352 to provide hysteresis plot 354. FIG. 8C is a diagram illustrating one embodiment of applying bow2 basis function 348 in a multiplicative symmetric template for a pincushion2 mode 356. Bow2 basis function 348 is applied to hysteresis plot 358 to provide hysteresis plot 360. Bow2 basis function 348 can also be applied in an inverse multiplicative template for FIG. 8C. Bow2 basis function 348 is illustrated as applied in FIGS. 8B and 8C in the horizontal direction, however, bow2 basis function 348 can also be applied in the vertical direction.

FIG. 9A is a diagram illustrating one embodiment of a mound basis function 370. Mound basis function 370 has the following function properties: symmetric, bi-monotonic, nonzero finite valued at origin, asymptotically constant. FIG. 9B is a diagram illustrating one embodiment of applying mound basis function 370 in an additive template for a bump mode 372. Mound basis function 370 is applied to hysteresis plot 374 to provide hysteresis plot 376. FIG. 9C is a diagram illustrating one embodiment of applying mound basis function 370 in a multiplicative symmetric template for a bulge mode 378. Mound basis function 370 is applied to hysteresis plot 380 to provide hysteresis plot 382. Mound basis function 370 can also be applied in an inverse multiplicative template for FIG. 9C. Mound basis function 370 is illustrated as applied in FIGS. 9B and 9C in the horizontal direction, however, mound basis function 370 can also be applied in the vertical direction.

FIG. 10A is a diagram illustrating one embodiment of a sigmoid basis function 384. Sigmoid basis function 384 has the following function properties: antisymmetric, strictly monotonic, with a 2^{nd} derivative whose sign matches that of the abscissas (i.e., h*h″>=0). FIG. 10B is a diagram illustrating one embodiment of applying sigmoid basis function 384 in an additive template for a sigmoid mode 386. Sigmoid basis function 384 is applied to hysteresis plot 388 to provide hysteresis plot 390. FIG. 10C is a diagram illustrating one embodiment of applying sigmoid basis function 384 in a multiplicative symmetric template for a bell mode 392. Sigmoid basis function 384 is applied to hysteresis plot 394 to provide hysteresis plot 396. FIG. 10D is a diagram illustrating one embodiment of applying sigmoid basis function 384 in a multiplicative antisymmetric template for a sigmoid2 mode. Sigmoid basis function 384 is applied to hysteresis plot 400 to provide hysteresis plot 402. Sigmoid basis function 384 can also be applied in an inverse multiplicative template for FIGS. 10C and 10D. Sigmoid basis function 384 is illustrated as applied in FIGS. 10B-10D in the horizontal direction, however, sigmoid basis function 384 can also be applied in the vertical direction.

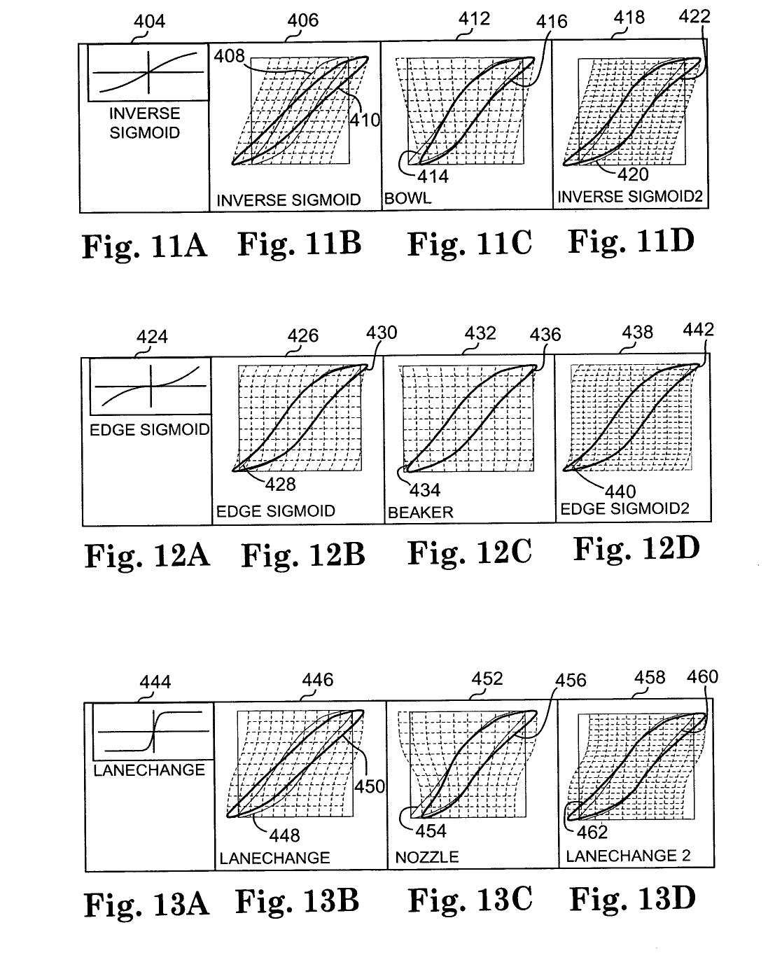

FIG. 11A is a diagram illustrating one embodiment of an inverse sigmoid basis function 404. Inverse sigmoid basis function 404 has the following function properties: antisymmetric, strictly monotonic, with a 2^{nd} derivative whose sign is opposite that of the abscissas (i.e., h*h″≦0). FIG. 11B is a diagram illustrating one embodiment of applying inverse sigmoid basis function 404 in an additive template for an inverse sigmoid mode 406. Inverse sigmoid basis function 404 is applied to hysteresis plot 408 to provide hysteresis plot 410. FIG. 11C is a diagram illustrating one embodiment of applying inverse sigmoid basis function 404 in a multiplicative symmetric template for a bowl mode 412. Inverse sigmoid basis function 404 is applied to hysteresis plot 414 to provide hysteresis plot 416. FIG. 11D is a diagram illustrating one embodiment of applying inverse sigmoid basis function 404 in a multiplicative antisymmetric template for an inverse sigmoid2 mode 418. Inverse sigmoid basis function 404 is applied to hysteresis plot 420 to provide hysteresis plot 422. Inverse sigmoid basis function 404 can also be applied in an inverse multiplicative template for FIGS. 11C and 11D. Inverse sigmoid basis function 404 is illustrated as applied in FIGS. 11B-11D in the horizontal direction, however, inverse sigmoid basis function 404 can also be applied in the vertical direction.

The shapes of the sigmoid and inverse sigmoid basis functions as used herein do not match those of conventional mathematical terminology. Basis function 404 should properly be called a sigmoid, and then 384 would be its inverse. To avoid confusion, the function names used herein should be understood as convenient tags, not as definitions.

FIG. 12A is a diagram illustrating one embodiment of an edge sigmoid basis function 424. Edge sigmoid basis function 424 has the following function properties: antisymmetric, strictly monotonic, with a 2^{nd} derivative whose sign matches that of the abscissas, slope (derivative) of zero at the center of anti-symmetry. FIG. 12B is a diagram illustrating one embodiment of applying edge siginoid basis function 424 in an additive template for an edge sigmoid mode 426. Edge sigmoid basis function 424 is applied to hysteresis plot 428 to provide hysteresis plot 430. FIG. 12C is a diagram illustrating one embodiment of applying edge sigmoid basis function 424 in a multiplicative symmetric template for a beaker mode 432. Edge sigmoid basis function 424 is applied to hysteresis plot 434 to provide hysteresis plot 436. FIG. 12D is a diagram illustrating one embodiment of applying edge sigmoid basis function 424 in a multiplicative antisymmetric template for a edge sigmoid2 mode 438. Edge sigmoid basis function 424 is applied to hysteresis plot 440 to provide hysteresis plot 442. Edge sigmoid basis function 424 can also be applied in an inverse multiplicative template for FIGS. 12C and 12D. Edge sigmoid basis function 424 is illustrated as applied in FIGS. 12B-12D in the horizontal direction, however, edge sigmoid basis function 424 can also be applied in the vertical direction.

FIG. 13A is a diagram illustrating one embodiment of a lanechange basis function 444. Lanechange basis function 444 has the following function properties: antisymmetric, strictly monotonic, and asymptotically constant. FIG. 13B is a diagram illustrating one embodiment of applying lanechange basis function 444 in an additive template for a lanechange mode 446. Lanechange basis function 444 is applied to hysteresis plot 448 to provide hysteresis plot 450. FIG. 13C is a diagram illustrating one embodiment of applying lanechange basis function 444 in a multiplicative symmetric template for a nozzle mode 452. Lanechange basis function 444 is applied to hysteresis plot 454 to provide hysteresis plot 456. FIG. 13D is a diagram illustrating one embodiment of applying lanechange basis function 444 in a multiplicative antisymmetric template for a lanechange2 mode 458. Lanechange basis function 444 is applied to hysteresis plot 460 to provide hysteresis plot 462. Lanechange basis function 444 can also be applied in an inverse multiplicative template for FIGS. 13C and 13D. Lanechange basis function 444 is illustrated as applied in FIGS. 13B-13D in the horizontal direction, however, lanechange basis function 444 can also be applied in the vertical direction.

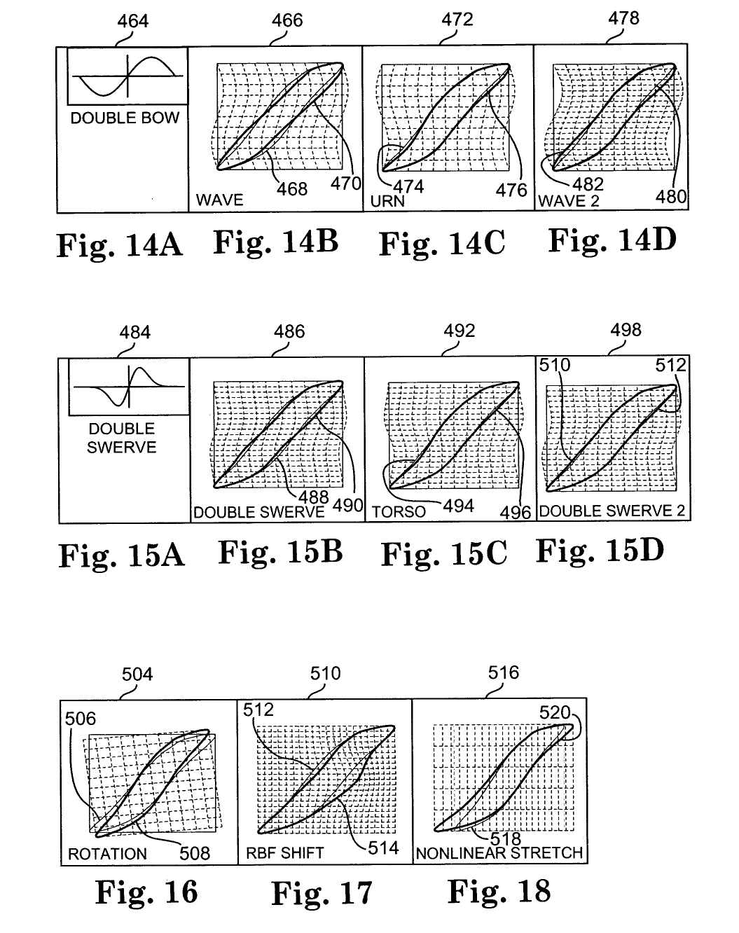

FIG. 14A is a diagram illustrating one embodiment of a double bow basis function 464. Double bow basis function 464 has the following function properties: odd; nonzero slope at origin; as move from origin, slope grad change to zero at local max or min; beyond max/min, slope reverses; finite zeros. FIG. 14B is a diagram illustrating one embodiment of applying double bow basis function 464 in an additive template for a wave mode 466. Double bow basis function 464 is applied to hysteresis plot 468 to provide hysteresis plot 470. FIG. 14C is a diagram illustrating one embodiment of applying double bow basis function 464 in a multiplicative symmetric template for an urn mode 472. Double bow basis function 464 is applied to hysteresis plot 474 to provide hysteresis plot 476. FIG. 14D is a diagram illustrating one embodiment of applying double bow basis function 464 in a multiplicative antisymmetric template for a wave2 mode 478. Double bow basis function 464 is applied to hysteresis plot 480 to provide hysteresis plot 482. Double bow basis function 464 can also be applied in an inverse multiplicative template for FIGS. 14C and 14D. Double bow basis function 464 is illustrated as applied in FIGS. 14B-14D in the horizontal direction, however, double bow basis function 464 can also be applied in the vertical direction.

FIG. 15A is a diagram illustrating one embodiment of a double swerve basis function 484. Double swerve basis function 484 has the following function properties: odd; nonzero slope at origin; as move from origin, slope grad change to zero at local max or min; beyond max/min, slope reverses and asymptotically approaches constant. FIG. 15B is a diagram illustrating one embodiment of applying double swerve basis function 484 in an additive template for a double swerve mode 486. Double swerve basis function 484 is applied to hysteresis plot 488 to provide hysteresis plot 490. FIG. 15C is a diagram illustrating one embodiment of applying double swerve basis function 484 in a multiplicative symmetric template for a torso mode 492. Double swerve basis function 484 is applied to hysteresis plot 494 to provide hysteresis plot 496. FIG. 15D is a diagram illustrating one embodiment of applying double swerve basis function 484 in a multiplicative antisymmetric template for a double swerve2 mode 498. Double swerve basis function 484 is applied to hysteresis plot 500 to provide hysteresis plot 502. Double swerve basis function 484 can also be applied in an inverse multiplicative template for FIGS. 15C and 15D. Double swerve basis function 484 is illustrated as applied in FIGS. 15B-15D in the horizontal direction, however, double swerve basis function 484 can also be applied in the vertical direction.

FIG. 16 is a diagram illustrating one embodiment of a rotation adjustment 504. Rotation adjustment 504 allows users to pivot the input-output pattern about any arbitrary point in the plane. Rotation adjustment 504 is applied to hysteresis plot 506 to provide hysteresis plot 508. Rotation adjustment 504 is performed through an angle ‘α’ in the input-output plane. In one embodiment, the rotation adjustment is defined by Equations XLIX and L as follows:
x′=(x−x_{c})cos α−(y−y_{c})sin α+xc Equation XLIX
Where:
   x′=a modified input signal value;
   x=an input signal value;
   y=an output signal value;
   α=the angle of rotation; and
   xc, yc=coordinates of the center of rotation.
      y′=(y−y_{c})cos α+(x−x_{c})sin α+yc Equation L
Where:
   x=an input signal value;
   y=an output signal value;
   y′=a modified output signal value;
   α=the angle of rotation; and
   xc, yc=coordinates of the center of rotation.

FIG. 17 is a diagram illustrating one embodiment of a Radial Basis Function (RBF) shift adjustment 510. RBF shift adjustment 510 is applied to hysteresis plot 512 to provide hysteresis plot 514. RBF shift adjustment 510 is defined by Equation XVIII for the vertical direction and by Equation XXXVIII for the horizontal direction.

FIG. 18 is a diagram illustrating one embodiment of a nonlinear stretch adjustment 516. Nonlinear stretch adjustment 516 is applied to hysteresis plot 518 to provide hysteresis plot 520. The nonlinear stretch adjustment is defined by Equations XIII-XVI for the vertical direction and by Equations XXXIII-XXXVII for the horizontal direction.

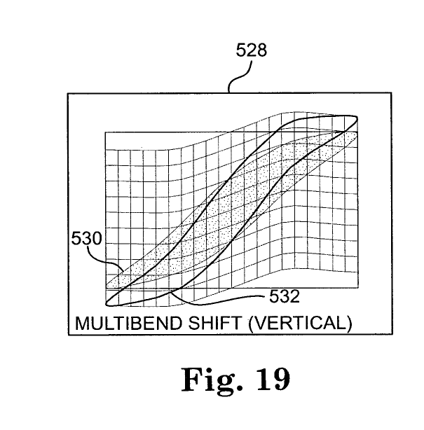

FIG. 19 is a diagram illustrating one embodiment of a multibend shift (vertical) adjustment 528. Multibend adjustments 528 use a multiple segment, piecewise linear, smooth transition function to shift a hysteresis backbone, or stretch the hysteresis width. Effectively, these adjustments are composites of the ‘hinge’ or ‘funnel’ adjustments described above. The advantage of the multibend function is that it can be specified more simply and directly than a series of hinges. Multibend shift adjustment 528 is applied to hysteresis plot 530 to provide hysteresis plot 532.

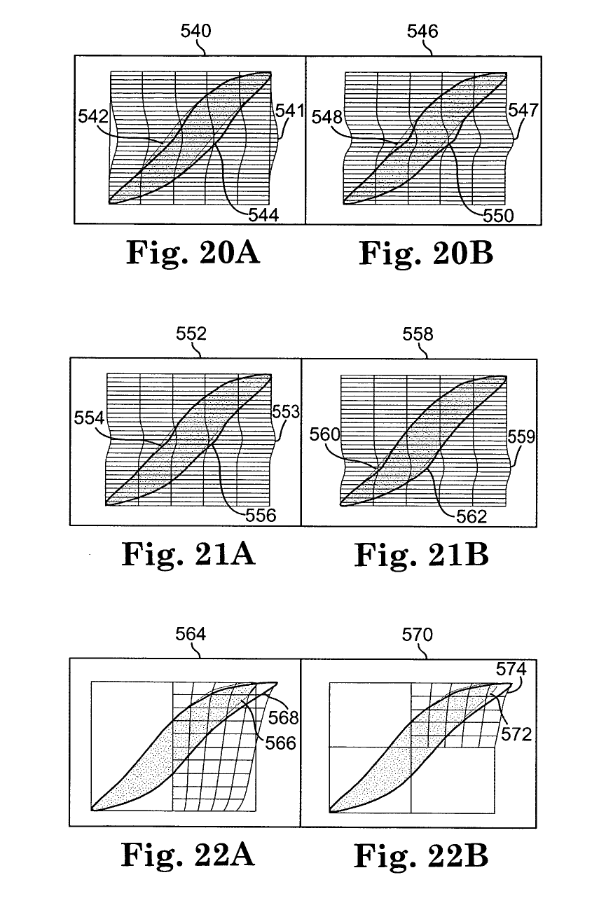

FIG. 20A is a diagram illustrating one embodiment of a bump adjustment 540 having a bump span, as indicated at 541. The span of the bump can be adjusted. The bump adjustment is applied to hysteresis plot 542 to provide hysteresis plot 544. FIG. 20B is a diagram illustrating another embodiment of a bump adjustment 546 having a different bump span, as indicated at 547. Bump adjustment 546 is applied to hysteresis plot 548 to provide hysteresis plot 550.

FIG. 21A is a diagram illustrating one embodiment of a bump adjustment 552 having a bump centerline, as indicated at 553. Centerline 553 of the bump can be adjusted. The bump adjustment is applied to hysteresis plot 554 to provide hysteresis plot 556. FIG. 21B is a diagram illustrating another embodiment of a bump adjustment 558 having a different bump centerline, as indicated at 559. Bump adjustment 558 is applied to hysteresis plot 560 to provide hysteresis plot 562. The span and centerline can be similarly adjusted for other modes based on the additive and multiplicative templates, by varying parameters a₂ and a₃.

FIG. 22A is a diagram illustrating one embodiment of a half-plane partial adjustment 564. Instead of changing the entire ‘screen,’ it may be useful to change only part of the screen. Half-plane partial adjustment 564 is applied to hysteresis plot 566 to provide hysteresis plot 568. Partial adjustments can be used with adjustment modes that leave the x and y axes unchanged and that give smooth transitions at those boundaries. FIG. 22B is a diagram illustrating one embodiment of a quarter-plane partial adjustment 570. Quarter-plane partial adjustment 570 is applied to hysteresis plot 572 to provide hysteresis plot 574.

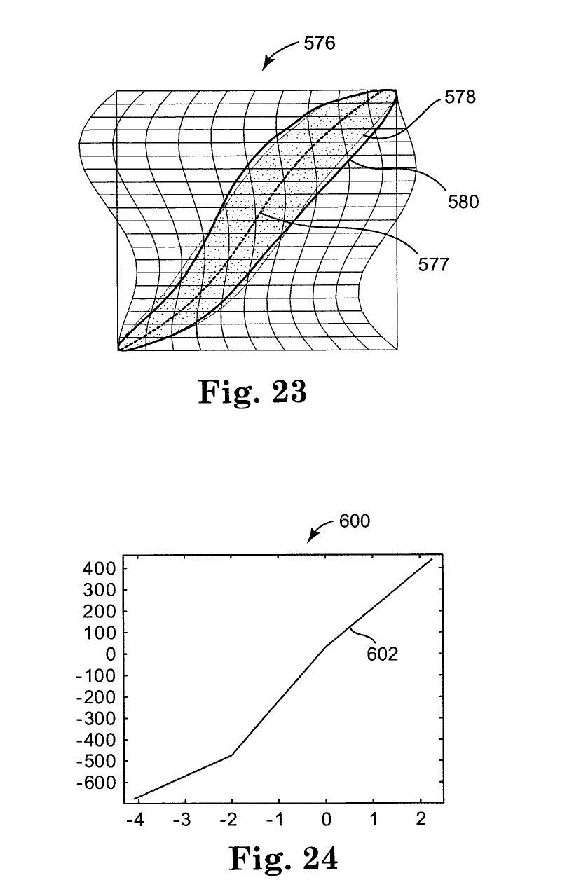

FIG. 23 is a diagram illustrating one embodiment of a backbone-centered adjustment 576. Adjustment modes such as horizontal pincushion 342 and trapezoid 308 act symmetrically about a vertical centerline. They may be used to increase the width of a hysteresis pattern. In doing so, however, they may also shift the backbone. Backbone-centered adjustments circumvent this problem, by substituting the backbone of a hysteresis pattern for the line of symmetry. This is demonstrated in FIG. 23, where a symmetric ‘urn’ mode 472 is applied relative to the backbone 577, to fatten the hysteresis in the upper half plane, and to constrict it in the lower half plane. Note that the (dashed) backbone 577 remains unchanged. In one embodiment, the ‘backbone’ curve x_{c}(y) 602 is a geometrical (horizontal) bisector of the hysteresis pattern. Alternatively, the backbone may be obtained as a nonlinear instantaneous model, in the form of a least-squares line, a polynomial, a cubic spline, a feedforward neural network, or a ‘smooth piecewise linear’ function, as illustrated in FIG. 24. This model includes parameters to adjust the smoothness of the curves at the ‘bends.’

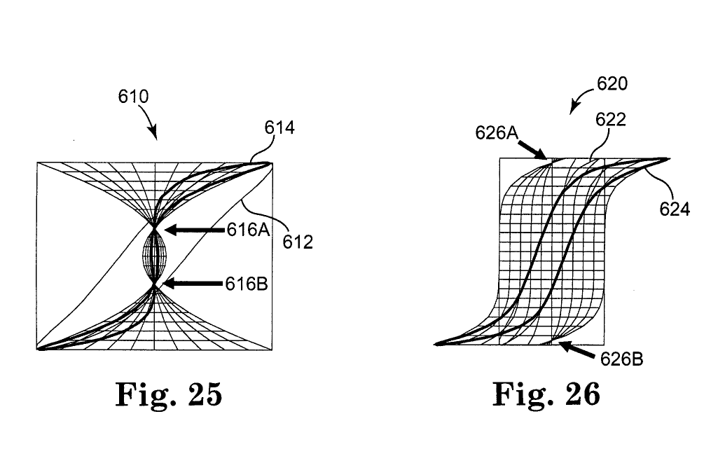

FIG. 25 is a diagram illustrating one embodiment of singular behavior 610 for a high amplitude adjustment. FIG. 26 is a diagram illustrating another embodiment of singular behavior 620 for a high amplitude adjustment. The adjustment modes of embodiments of the invention are all designed to be non-singular (i.e., invertible) for a limited range of amplitudes. Some of the adjustments, however, can become singular at sufficient magnitudes, as demonstrated in FIG. 25, which shows the effect of using a large negative amplitude for the horizontal pincushion mode 342 and in FIG. 26 for the edge sigmoid 438 (multiplicative) mode.

Both plots show singular behavior (as indicated at 616A, 616B, 626A, and 626B by arrows pointing to crossovers). The crossovers 616A and 616B for the pincushion 610 are clearly a problem, but the crossovers 626A and 626B for the inverse sigmoid2 620 may be innocuous as they occur far from the regions of normal behavior. It may seem that the simplest way to avoid trouble is just to prevent a user from entering any amplitude that causes a singularity. This is generally too restrictive, since even the simple pincushion has inevitable crossovers at positive amplitudes at points outside of the adjustment application range. Such singularities should be allowed, but a user should be informed as to the fact that they are present in case they come close to the model validity range. Another source of singular behavior arises when a series of adjustments is applied.

In one embodiment, a test is used to check for and report singular behavior to the user. One test that is widely known and can be used for testing for singular behavior is the Jacobian test, in which a Jacobian determinant of the coordinate transformation equals zero. The test can be used for informing the user of possible erroneous behavior for 2D model adjustments.

An important consideration when simulating with blackbox models is whether the model predictions are valid, in the sense that they are based on inputs and outputs of magnitude similar to those used for generating the model. That is, when a set of input-output data representing measured physical system behavior is used to construct a blackbox model, the minimum and maximum values of those data define the range over which fitted equations may be considered to apply with reasonable accuracy, and beyond which the fitted equations may have an indeterminate accuracy. These maximum and minimum values effectively serve as ‘validity’ boundaries, against which actual input and output values may be compared, during simulation with the blackbox model, to indicate that the model is producing accurate or inaccurate results. The validity boundaries may alternatively be understood as the boundaries within which model predictions are formed as an interpolation of the measurement data that was used to generate them, and beyond which the predictions are extrapolations of that data.

Validity boundaries can be specified in other ways, besides the minimum and maximum values of inputs and outputs. One way is to specify that a functional combination of the current input and one or more past values should not exceed some value. For example, if the input signal represents a physical displacement, the difference between the current and previous values, divided by the time interval, is an estimate of the input velocity; for some models, it may be prudent to track this value and compare it to maximum and minimum values encountered in the model generation data. A similar approach is to form a functional combination of input and output signals, or of multiple input and output signals, if available. All of these boundaries share the characteristic that a computed numerical value lies within some range to ensure validity. However, it may happen that a model's validity is associated with numerical values outside of some interval. For example, very small input values may be considered invalid if they are of comparable magnitude to the noise level of inputs used to generate the model, whereas larger amplitude inputs are acceptable, subject to normal minimum and maximum boundaries.

Each of these separate conditions for validity will be referred to as a ‘limit check’ in the following discussions, and a ‘limit checking system’ will refer to software components (algorithms, data structures, and gui elements) whose purpose is to compare current inputs and outputs to validity boundaries, and to report any violations to the user.

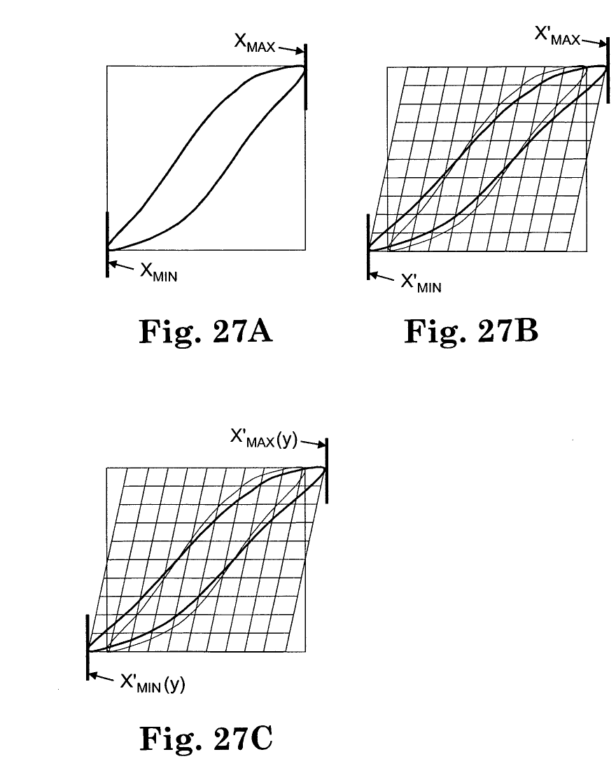

The validity limits of a model should be changed whenever the model is adjusted. When the adjustments are limited to stretching & shifting, the new limits are obtained simply by applying the adjustment to the original limit values. With CRT adjustments, however, original limits specified as constants (e.g., the input maximum is independent of the output) transform into functions (e.g., the input maximum is a function of the output). This is demonstrated in FIGS. 27A-27C. FIG. 27A shows a hysteresis loop of the model bounded by maximum and minimum input limits. Strict application of a parallelogram adjustment 302 changes xmax (a line of constant input) into a sloped line (FIG. 27C). These boundaries are precise, but implementation may be cumbersome. FIG. 27B presents an alternative approach, where the input maximum for the adjusted model is set to be a constant. This value requires that some corresponding y value be chosen, and the obvious choice in this case is y=yₘₐₓ. For other models, this may not be the best choice. The adjusted limit value is defined as a constant for some choice of y, but which particular value of y is used is not specified. In one embodiment, functions can be used for adjusted limits.

In one embodiment, a model limit system is defined, in which the input limit values are specified as constants (independent of the associated output value), and in which the limits are modified in accordance with any of the model adjustments covered in Equations V-L that employ an output-dependent input adjustment of the form x′=g(x,y), such that the modified input limit value x′* is a constant (not a function of output) obtained by using an input limit value x* and an output value y* with the function g via x′*=g(x*,y*).

In another embodiment, a model limit system is defined, in which the output limit values are specified as constants (independent of the associated input value), and in which the limits are modified in accordance with any of the model adjustments covered in Equations V-L that employ an input-dependent output adjustment of the form y′=g(x,y), such that the modified output limit value y′* is a constant (not a function of input) obtained by using an input value x* and an output limit value y* with the function g via y′*=g(x*,y*).

In another embodiment, a model limit system is defined, in which the input limit values are specified as constants (independent of the associated output value), and in which the limits are modified in accordance with any of the model adjustments covered in Equations V-L that employ an output dependent input adjustment of the form x′=g(x,y), such that the modified limit values are specified as functions of the output, consistent with the function g.

In another embodiment, a model limit system is defined, in which the output limit values are specified as constants (independent of the associated input value), and in which the limits are modified in accordance with any of the model adjustments covered in Equations V-LIV that employ an input-dependent output adjustment of the form y′=g(x,y), such that the modified limit values are specified as functions of the input, consistent with the function g.

In one embodiment, a method adjusts the input-output relation of a model of physical system, in which the adjustments are checked for non-invertibility (i.e., for any case where the adjustment function g(x,y) would map two distinct input-output points to the same point). In another embodiment, the checking is applied to those input-output points contained within a set of input and output limits, and for which any associated warnings or records of limit exceedances are qualified as occurring within those limits. In another embodiment, the checking is applied to those input-output points contained beyond a set of input and output limits, and for which any associated warnings or records of limit exceedances are qualified as occurring beyond those limits.

The CRT adjustment methods can be applied in many ways. Two general ways in which the CRT adjustments can be applied include empirical interpolation and exploration.

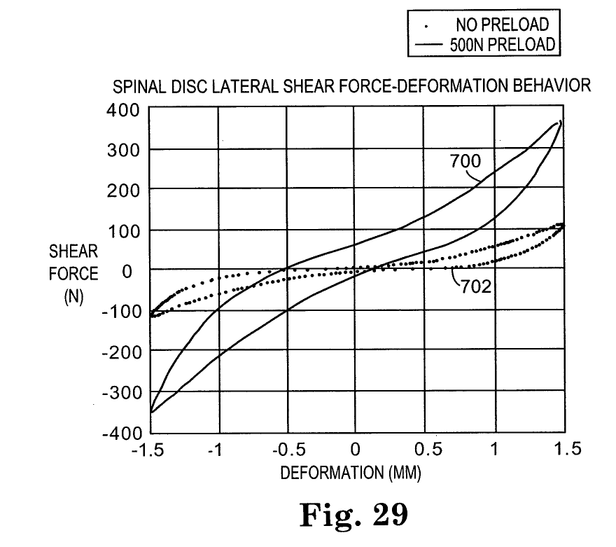

Empirical interpolation is useful for situations where laboratory test data is available for two or more related components, but information about the behavior is required for a case that was not measured. For example, biomedical engineers who design spinal fixation devices or prosthetic intervertebral discs may require information about the nonlinear force-deformation behavior of natural intervertebral discs. This information can be obtained from laboratory measurements as illustrated in FIG. 29. Each plot 700 and 702 illustrates a nonlinear, hysteretic relation between lateral shear force and lateral shear displacement. The plots 700 and 702 differ in the amount of vertical preload present. If at some time after the laboratory tests are complete, the engineers decide that the behavior at an intermediate preload is needed, they can use the CRT adjustment methods to interpolate between the existing data sets, thereby avoiding much time and effort to setup and run new lab tests.

Exploration is useful for situations where designers wish to evaluate behavior outside the range of existing components. For example, automotive suspension designers may seek to improve the fatigue life of a vehicle body, by changing the dynamic behavior of the jounce bumpers (i.e., elastomeric components that limit the vertical travel of the wheels upward toward the vehicle body). Throughout most of a vehicle's operational life, the jounce bumpers are rarely used−they come into play only when extreme events (such as pothole strikes or curb strikes) occur. Unfortunately, these few events are associated with large loads into the vehicle body, which can accelerate fatigue crack formation at critical locations.

As a result, body designers have a strong incentive to predict jounce bumper loads accurately. Ideally, they will prefer to use computer models for this purpose, to minimize time and cost (i.e., compared to laboratory or test track evaluations). Unfortunately, such predictions are very difficult, for several reasons. The jounce bumper loads depend on interactions between various suspension components: the velocity at impact is determined by shock absorber and tire characteristics. Furthermore, the position of the vehicle body, which is defined by the history of inputs at all four wheels, is taken into account. As a result, a computer model of the full vehicle body and chassis is needed, to evaluate the jounce bumpers' influence on fatigue behavior.

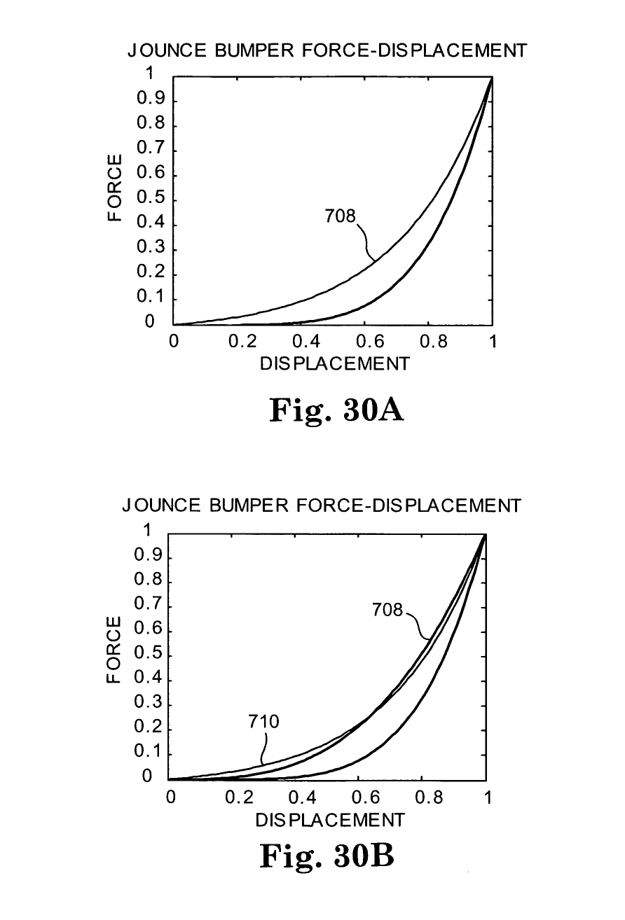

Jounce bumpers are designed to be both nonlinear and hysteretic, so as to progressively dissipate energy from excessive suspension motions. FIG. 30A illustrates typical force-deformation behavior for such a bumper, indicated by hysteresis loop 708. The complex combination of nonlinear and hysteretic behavior of this loop is difficult to model accurately using whitebox techniques. An advanced blackbox model (e.g., a time-delay neural network) may provide a significant benefit in this regard. After building a blackbox model from laboratory test data, the model can be embedded into the larger vehicle system (whitebox) model for fatigue evaluations.

Suppose that such a model has been used to evaluate several existing bumper designs, and that none of the existing bumpers gave the desired fatigue performance. In this case, the CRT adjustment methods make it possible to extrapolate the dynamic characteristics from one or more of the existing designs. For example, it may be beneficial to reduce the amount of hysteresis at low amplitudes, while increasing it slightly at higher amplitudes, by shifting the upper curve of the hysteresis loop, as indicated at 710 in FIG. 30B. The suspension designer can determine whether such a modification leads to a suitable improvement in fatigue life, without being constrained by existing bumper designs. The extrapolated blackbox can then be used to communicate the new behavioral requirements to the bumper designers, who will be responsible for translating the new requirements into a physically realizable product (e.g., by altering geometric shape or chemical composition of the bumper).

The following section describes ‘coefficient adjustment,’ an alternative method to adjust parameters of a blackbox model. Unlike the CRT method previously described, which modifies the time histories that are subsequently used to generate a blackbox model, coefficient adjustment modifies the blackbox model directly. In one embodiment, coefficient adjustment is faster than the CRT adjustment method and enables parameters to be changed during simulation with the model. Additionally, in one embodiment, coefficient adjustment is more powerful than the CRT adjustment method in that the coefficient adjustment can represent a wider range of parametric variations than is possible with CRT adjustments.

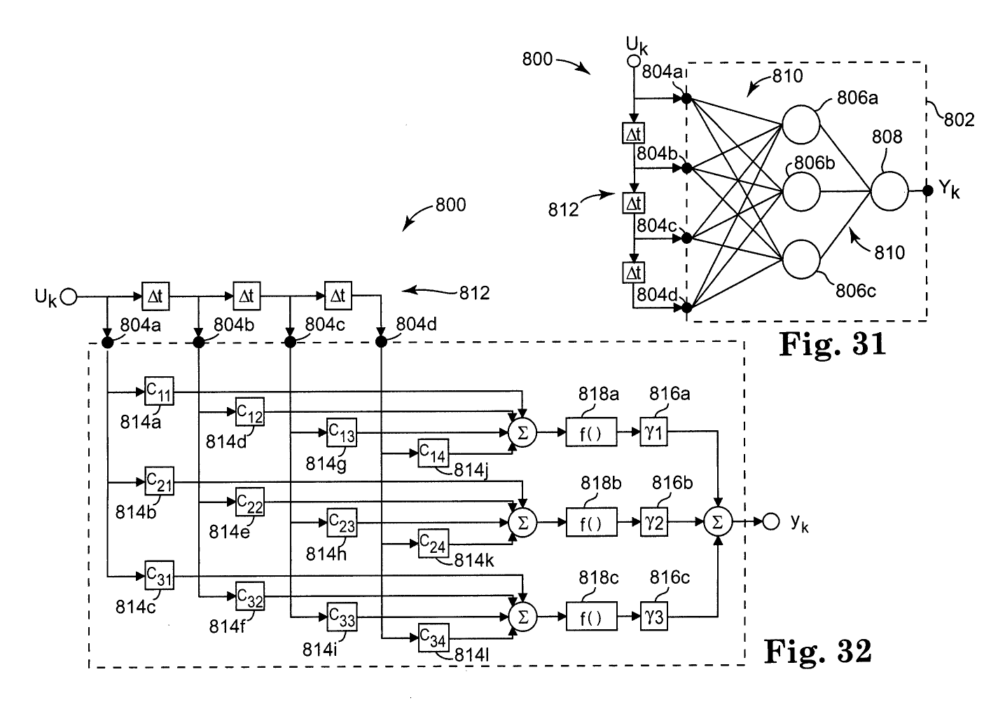

In coefficient adjustment, the coefficients (weights) of the blackbox model, which are normally treated as fixed values after model generation is completed, are treated as variables that depend on a physical parameter. Coefficient adjustment can be used to advantage when a conventional feedforward time-delay neural network 800 is used as the blackbox model as illustrated in FIG. 31. Block 802 contains the neural network proper, where the four small black circles 804a-804d at the left edge represent neural network inputs, the three central large open circles (‘hidden units’) 806a-806c represent summation and nonlinear processing, the rightmost open circle 808 represents a simple linear summation. Lines 810 between the circles represent signal connections, with implicit multiplication by weights (a.k.a. coefficients). Outside block 803 is a tap delay line 812, which accumulates multiple values of input uₖ (where k is a discrete time index) to produce a sequence {uₖ, . . . uₖ₋₃} (i.e., a history of current and recent past inputs, which are used by neural network 800 to model time-dependent effects).

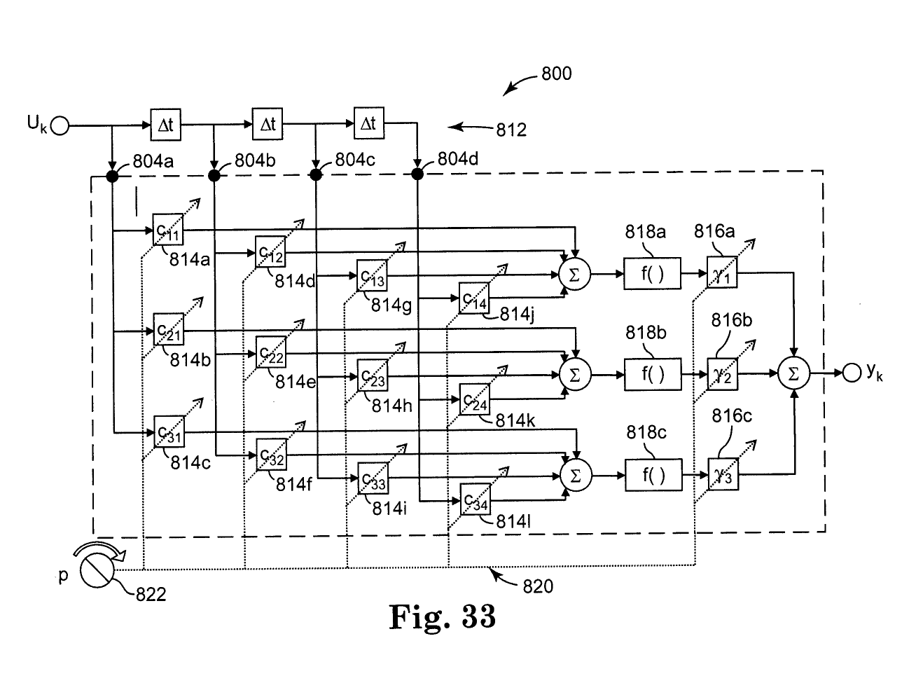

FIG. 32 represents the same neural network 800 as FIG. 31, but with the coefficients cᵢⱼ 814a-814l and γᵢ 816a-816c illustrated explicitly, as well as the nonlinear functions f( ) 818a-818c. To implement the coefficient adjustment technique for this neural network, each coefficient is regarded not as a constant but as a function of a physical parameter ‘p.’ In function notation, cᵢⱼ=cᵢⱼ(p) and γᵢ=γᵢ(p). The dependence of all coefficients on (the same) p is also illustrated in FIG. 33, using inclined arrows 820 through each coefficient box 814a-814l to represent variability, all of which are tied to a ‘ [symbol] ’ symbol 822 to represent some independent means to adjust p.

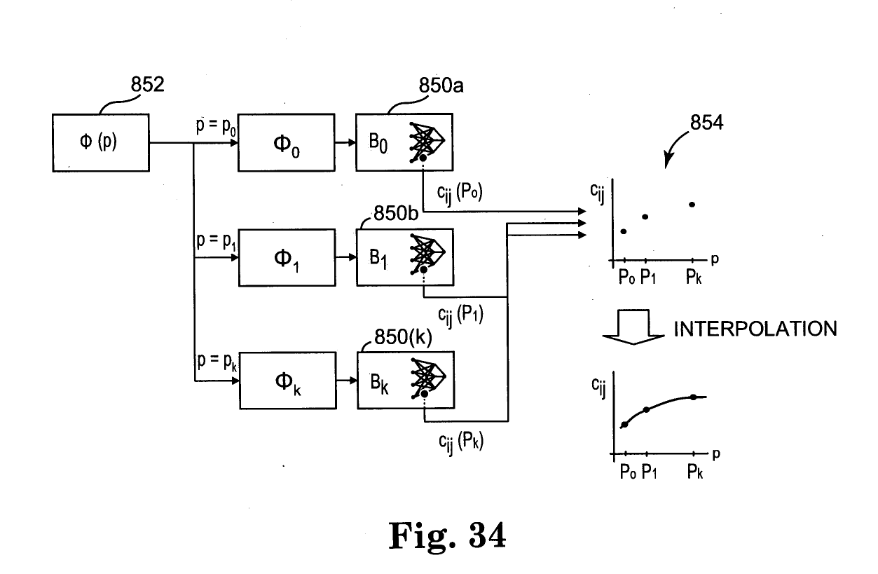

Use of functions cᵢⱼ(p) and γᵢ(p) rather than constants cᵢⱼ and γᵢ is an extension of the prior art for neural networks. One reason is that, the conventional neural network techniques are designed to generate a set of constants, not functions. To generate functions rather than constants, the coefficient adjustment technique interpolates coefficients over a set of conventional neural network models, which represent a series of physical systems that are all alike but for differences in a physical parameter p. This is illustrated in FIG. 34, which depicts physical system Φ(p) 852 whose behavior depends on physical parameter p. For several distinct values p₁, p₂, . . . pₖ of the parameter p, the system is modeled to yield blackbox models B₀ . . . Bₖ 850a-850(k). Taking the same coefficient cᵢⱼ from each of these models and interpolating with respect to the parameters p yields a smooth function cᵢⱼ(p), as indicated at 854. This interpolation process is repeated for all the coefficients of the neural network. The functions cᵢⱼ(p) can be constructed using any conventional nonlinear regression functional form, e.g., polynomials, splines, or even another neural network.

In one embodiment, all the neural networks of the series have the same dimensions (i.e., number of inputs from the tapped delay line, and number of hidden units) for interpolating smoothly between models. In another embodiment, a non-interpolative table lookup procedure is used.

In one embodiment, the neural network coefficient corresponding to any given position (defined by subscripts i and j for coefficient c, or i for coefficient γ) are related to the parameter p in a consistent manner from one model to the next (in the interpolation set). Unfortunately, this will not normally be satisfied using conventional model generation methods. Normally, coefficients are determined in a non-unique and ‘variable position’ manner. Non-uniqueness in this case means that a satisfactory solution (or fit, between the model inputs and outputs) may be represented by many different sets of coefficients for a given error level. ‘Variable position’ means that even a single set of coefficients can be rearranged to give the exact same result. This is evident in FIG. 32, in that rearrangement of rows (subscript i) of the matrix cᵢⱼ, along with positions of the γᵢ, do not affect the final result.

Both of these effects result from the use of nonlinear optimization algorithms, which seek to minimize a cost function (e.g., sum of squared errors) through a ‘downhill search,’ using information about the gradient (of error with respect to coefficients) and similar operators to determine the downhill direction. This process begins with a random initial guess for the coefficient values and proceeds to a nearby local minimum for the cost function. This minimum may not be global, so multiple searches are normally employed, each beginning with a different random starting point. There is no guarantee that this multiple search process will locate the global minimum, and the process is terminated when the cost function reaches a predefined acceptable value, or appears to give negligible improvement with further calculation, or when a practical time limit is reached. The random start and nebulous termination produce a non-unique solution to the optimization problem. In some respects, the final set of coefficients is strongly dependent on the random initial values used to start each search attempt.

Non-unique and variable position coefficients cannot be used for model interpolation, as there is no consistent, meaningful relationship between the coefficients and the physical parameter p. To circumvent this limitation, the series of blackbox models used are defined in a special manner. Specifically, the normal training method is constrained, so as to maintain position-wise correspondence of coefficients between models.

A second feature of the coefficient adjustment technique is a method to circumvent the obstacles to interpolation described above. This method consists of two constraints to be applied to the conventional modeling method: (1) For the model training data, the input signal should be the same for all the neural networks of the series. (2) After the first model of the series is generated using a conventional method (i.e., starting from a randomly selected coefficient vector), subsequent models should be trained using the converged coefficients of one of the trained models, instead of a randomly selected coefficient vector. The objective of these constraints is to force the coefficient values for similar models to converge in the ‘same neighborhood’ of the coefficient space. These constraints will be most effective when the differences between parameter values are small.

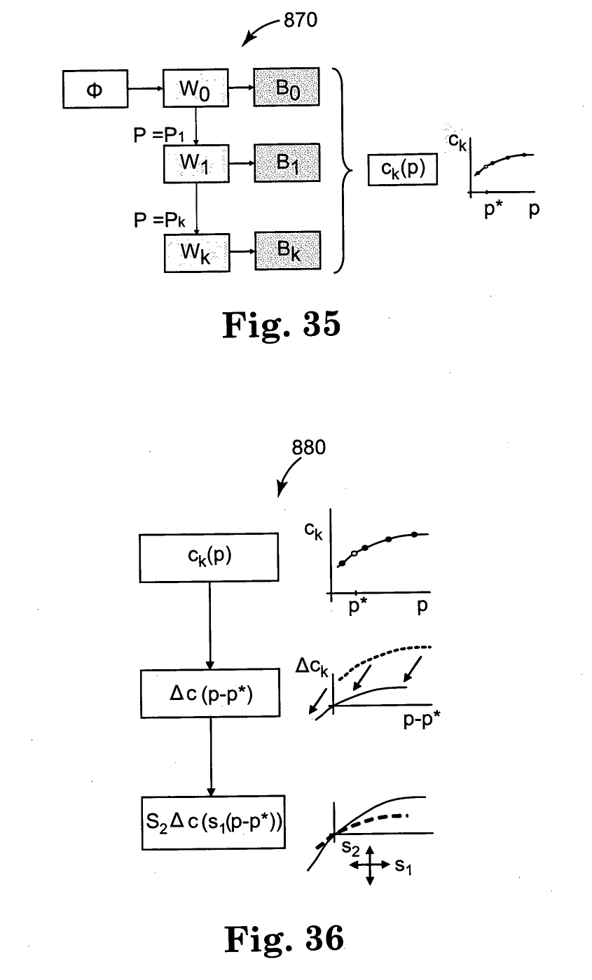

Once the functions cᵢⱼ(p) are determined, the parameterized-coefficient neural network can be used to represent a range of physical systems that differ in parameter p. The description above suggested that the blackbox models were generated using input and output signals obtained directly from physical specimens (i.e., from laboratory tests). It should be evident that the current invention could instead be applied to data obtained from a series of whitebox models, as illustrated in FIG. 35 at 870. This may be useful for cases where the blackbox is faster than the equivalent whitebox model, and parametric adjustment is required.

A further embodiment of the invention is to extend the previous methods, so that adjustments may be applied to a model of a physical system Φ* that differs slightly from those used for interpolation (i.e., it differs in one or more other parameters q, r, s . . . , different from p). In this case, the coefficient functions cᵢⱼ(p) and γᵢ(p) are used in a differential or relative manner, to provide a correction to a reference parameter p* associated with system Φ*. The correction functions are generated as follows: starting from reference parameter p*, the coefficient functions are shifted to use an argument Δp=p−p*, and to give an output Δcᵢⱼ(Δp)=cᵢⱼ(p)−cᵢⱼ(p*). This is illustrated graphically in FIG. 36 at 880. Once these differential functions are formed, they may be stretched along either the Δp axis or the Δc axis, using factors s₁ and s₂ to give new interpolation functions: Δcᵢⱼ′=s₂Δcᵢⱼ(s₁Δp). This stretched function defines a correction to be added to any coefficient of a blackbox model B* (representing Φ*) to simulate a change in p to p*.

The above process assumes that the true effect of a parameter change on Φ* is similar to the effect on Φ, such that the two are related via an affine function (linear w/offset). Unfortunately, there is no clear way to define the scaling parameters s₁ and s₂, without a whitebox model for Φ*. To circumvent this, it is useful to qualify the technique with a number of specimens and their corresponding white and blackbox models, to determine general values of s₁ and s₂. For example, these values can be obtained for a class of specimens (e.g., shock absorbers), after which further application of the corrections can be performed without extra effort.

In one embodiment, the input-output relation of a model of physical system is adjusted, in a manner consistent with the adjustment of a parameter of a physical system, by a process consisting of the following steps:
a) Generate a ‘whitebox’ (aka, first-principles, structural, or analytical) model W of a physical system Φ.
b) Optimize the parameters of the whitebox model so that the it gives an accurate estimate of the behavior of the actual physical system, under a wide variety of conditions; call the set of parameters p₀, and the optimized whitebox W₀.
c) Generate a set of input-output pairs using the whitebox model, and use these to build a blackbox model B₀.
d) Adjust one or more parameters of the whitebox model to give a new parameter set p₁, thereby defining a new whitebox model W₁.
e) Generate a new set of input-output pairs using the adjusted whitebox model W₁, and use these to build a blackbox model B₁ having the same structure as B₀.
f) Repeat steps d and e for a variety of parameter values, to yield models Wⱼ, Bⱼ, j=1, 2, . . . , corresponding to parameter sets p₀, p₁, . . .
g) Using nonlinear regression techniques, define functions cₖ=cₖ(p) between the whitebox parameter values and the blackbox model coefficient (weight) values (cₖ=blackbox model coefficient k, p=whitebox parameter set (vector)).
h) For a physical system Φ* similar to Φ, for which a whitebox model may not exist, with parameters p* in the range of, or similar to those of, p0, p1, . . . pM, build a blackbox model B* having a structure that matches models Bi.
i) Using the functions cₖ=cₖ(p), define blackbox coefficient correction functions Δcₖ(ΔP), where Δcₖ=cₖ(p)−cₖ(p*) and Δp=p−p*.
j) Model B* can now be adjusted in a manner that simulates the a whitebox parameter variation Δp by applying the coefficient correction functions Δcₖ to the coefficients c* of B*.

In one embodiment, a neural network is used as the nonlinear regression structure for step g. In one form of the invention, a cubic spline curve is used as the regression function when a single parameter is varied. In one embodiment, a polynomial curve is used as the regression function when a single parameter is varied. In one form of the invention, the neural network is generated using nonlinear optimization methods which require an initial estimate of the model coefficients, where the initial estimate of the coefficients for model Bₖ are taken from the final coefficient set of a previously generated model Bⱼ having a similar parameter set (pₖ≅pⱼ). In one embodiment, a possible discrepancy between models B(p*) and B*(p*) is corrected by modifying the value of p* to a new value p**, i.e., so that B(p**) more closely matches the model B*(p*), and then using p** instead of p* to define the correction function Δcₖ( ).

The coefficient adjustment method was described above for the case of a single physical variable p. The method can be readily extended to work for the case where the effects of multiple physical parameters (p1, p2 . . . ) are of interest, by using multiple regression techniques to interpolate between sets of conventional blackbox models (that vary in those parameters).

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A system for modeling a physical system comprising:
an interface configured to receive user inputs defining an adjustment mode and an amplitude for modifying a time history of a physical system, the adjustment mode comprising a function template and a basis function; and
a calculation engine configured to receive the time history of the physical system, modify the time history based on the defined adjustment mode and the amplitude, and output the modified time history, which is used to build a modified model of the physical system.

2. The system of claim 1, wherein the time history comprises input data and output data.

3. The system of claim 1, wherein the interface is configured to plot the time history and the modified time history.

4. The system of claim 1, wherein the engine is configured to modify the time history based on the defined adjustment mode in an interactive mode.

5. The system of claim 1, wherein one of the interface and the calculation engine is configured to provide a script comprising a sequence of one or more adjustment modes.

6. The system of claim 5, wherein the engine is configured to receive the script and modify the time history based on the script in an automatic mode.

7. The system of claim 1, wherein the adjustment mode comprises one of an additive function template, a multiplicative function template, an inverse multiplicative function template, a non-linear stretch function template, and a radial basis function shift function template.

8. The system of claim 1, wherein the adjustment mode comprises one of a linear basis function, a multi-hinge basis function, a bow basis function, a bow2 basis function, a mound basis function, a sigmoid basis function, an inverse sigmoid basis function, an edge sigmoid basis function, a lanechange basis function, a double bow basis function, and a double swerve basis function.

9. The system of claim 1, wherein the adjustment mode comprises one of a rotation adjustment mode, a parallelogram adjustment mode, a trapezoid adjustment mode, a bow adjustment mode, a pincushion adjustment mode, a rotate adjustment mode, a bump adjustment mode, a bulge adjustment mode, a sigmoid adjustment mode, an edge sigmoid adjustment mode, an inverse sigmoid adjustment mode, a bell adjustment mode, a hinge adjustment mode, a funnel adjustment mode, a nozzle adjustment mode, a wave adjustment mode, an urn adjustment mode, a double swerve adjustment mode, a lanechange adjustment mode, a bowl adjustment mode, a beaker adjustment mode, a torso adjustment mode, a twist adjustment mode, a bow2 adjustment mode, a pincushion adjustment mode, a wave adjustment mode, a lanechange2 adjustment mode, an inverse sigmoid2 adjustment mode, an rbf shift adjustment mode, and a non-linear stretch adjustment mode.

10. A system for modeling a physical system, the system comprising:
a computer system configured for executing a modeling system application, the application including:
an interface component configured to receive inputs defining an adjustment mode and an amplitude for modifying a time history of a physical system, the adjustment mode comprising a function template and a basis function;
an engine component configured to receive the time history of the physical system, modify the time history based on the defined adjustment mode and the amplitude, and output the modified time history;
wherein the adjustment mode comprises one of an additive function template, a multiplicative function template, an inverse multiplicative function template, a non-linear stretch function template, and a radial basis function shift function template; and
wherein the adjustment mode comprises one of a linear basis function, a multi-hinge basis function, a bow basis function, a bow2 basis function, a mound basis function, a sigmoid basis function, an inverse sigmoid basis function, an edge sigmoid basis function, a lanechange basis function, a double bow basis function, and a double swerve basis function.

11. A method for modeling a physical system, the method comprising:
receiving a time history for a physical system;
selecting an adjustment mode comprising a function template and a basis function;
selecting an amplitude; and
applying the adjustment mode and the amplitude to the time history.

12. The method of claim 11, further comprising:
plotting output data versus input data from the time history.

13. The method of claim 11, further comprising:
setting a backbone for the time history.

14. The method of claim 13, wherein applying the adjustment mode to the time history comprises applying the adjustment mode with respect to the backbone.

15. The method of claim 13, wherein setting the backbone for the time history comprises setting the backbone for the time history comprising one of a straight line, a static neural network, a polynomial, a cubic spline model, and a smooth piecewise-linear function.

16. The method of claim 11, further comprising:
selecting quadrants for applying the adjustment mode.

17. The method of claim 11, further comprising:
adjusting one of an offset and span of the adjustment mode.

18. The method of claim 11, wherein applying the adjustment mode to the time history comprises applying the adjustment mode to input data of the time history.

19. The method of claim 11, wherein applying the adjustment mode to the time history comprises applying the adjustment mode to output data of the time history.

20. The method of claim 11, wherein selecting the adjustment mode comprises selecting one of an additive function template, a multiplicative function template, an inverse multiplicative function template, a nonlinear stretch function template, and a radial basis function shift function template.

21. The method of claim 11, wherein selecting the adjustment mode comprises selecting one of a linear basis function, a multi-hinge basis function, a sigmoid basis function, an inverse sigmoid basis function, an edge sigmoid basis function, a lanechange basis function, a double bow basis function, and a double swerve basis function.

22. The method of claim 11, wherein selecting the adjustment mode comprises selecting one of a rotation adjustment mode, a parallelogram adjustment mode, a trapezoid adjustment mode, a bow adjustment mode, a pincushion adjustment mode, a rotate adjustment mode, a bump adjustment mode, a bulge adjustment mode, a sigmoid adjustment mode, an edge sigmoid adjustment mode, an inverse sigmoid adjustment mode, a bell adjustment mode, a hinge adjustment mode, a funnel adjustment mode, a nozzle adjustment mode, a wave adjustment mode, an urn adjustment mode, a double serve adjustment mode, a lanechange adjustment mode, a bowl adjustment mode, a beaker adjustment mode, a torso adjustment mode, and a non-linear stretch adjustment mode.

23. The method of claim 11, wherein applying the adjustment mode to the time history comprises applying the adjustment mode to a derivative of the time history.

24. The method of claim 11, wherein receiving the time history for the physical system comprises receiving a time history of input and output signals of one of a shock absorber, a rubber bushing, and a tire.

25. The method of claim 11, wherein receiving the time history for the physical system comprises receiving the time history of input and output signals for a biological system.

26. The method of claim 11, further comprising:
testing for singular behavior with the adjustment mode applied.

27. The method of claim 26, further comprising:
providing a warning if singular behavior is found.

28. The method of claim 11, further comprising:
setting validity limits for applying the adjustment mode to the time history.

29. The method of claim 11, wherein applying the adjustment mode comprises applying the adjustment mode to perform an empirical interpolation.

30. The method of claim 11, wherein applying the adjustment mode comprises applying the adjustment mode to perform an exploration.

31. An article of manufacture comprising:
a computer readable medium bearing code embodied therein for modeling a physical system and including:
a first computer readable code segment for receiving a time history for a physical system;
a second computer readable code segment for selecting an adjustment mode comprising a function template and a basis function;
a third computer readable code segment for selecting an amplitude; and
a fourth computer readable code segment for applying the adjustment mode and the amplitude to the time history.
